(19) United States
(12) Patent Application Publication
(10) Pub. No.: US 2025/0385425 A1
(43) Pub. Date: Dec. 18, 2025

(54) ANTENNA STRUCTURE AND ELECTRONIC DEVICE

(71) Applicant: HUAWEI TECHNOLOGIES CO., LTD., Shenzhen (CN)

(72) Inventors: Haobo Wu, Xi'an (CN); Shuming Yang, Xi'an (CN); Bing Liu, Xi'an (CN); Wei Zheng, Xi'an (CN); Qiao Sun, Xi'an (CN); Chi Fan, Xi'an (CN); Kun Li, Xi'an (CN); Jianming Gao, Xi'an (CN)

(73) Assignee: HUAWEI TECHNOLOGIES CO., LTD., Shenzhen (CN)

(21) Appl. No.: 19/246,709

(22) Filed: Jun. 24, 2025

Related U.S. Application Data
(63) Continuation of application No. PCT/CN2024/073526, filed on Jan. 22, 2024.

(30) Foreign Application Priority Data
Mar. 27, 2023 (CN) 202310344745.9
Jun. 14, 2023 (CN) 202310706987.8

(51) Int. Cl. H01Q 1/27; G04G 17/04; G04G 21/04; H01Q 1/36; H01Q 1/48

(52) U.S. Cl. CPC H01Q 1/273; G04G 17/04; G04G 21/04; H01Q 1/36; H01Q 1/48

(57) ABSTRACT

An antenna structure and an electronic device is provided. In the antenna structure, when a switch assembly is in a second state, at a target frequency, at least one of a second ground end and a third ground end may be electrically isolated from a ground plate, and a feeding end and a first ground end may excite a ring-shaped radiator to operate mainly in an antisymmetry mode. When the switch assembly is in a first state, the first ground end and at least one of the second ground end and the third ground end are electrically connected to the ground plate, and at least one of the second ground end and the third ground end, the feeding end, and the first ground end may excite the ring-shaped radiator to operate mainly in a symmetry mode.

### CROSS-REFERENCE TO RELATED APPLICATIONS

This application is a continuation of International Application No. PCT/CN2024/073526, filed on Jan. 22, 2024, which claims priorities to Chinese Patent Application No. 202310344745.9, filed on Mar. 27, 2023 and Chinese Patent Application No. 202310706987.8, filed on Jun. 14, 2023. All of the aforementioned applications are hereby incorporated by reference in their entireties.

### TECHNICAL FIELD

This application relates to the field of antenna technologies, and in particular, to an antenna structure and an electronic device.

### BACKGROUND

With continuous development and progress of science and technology, an electronic device with a mobile communication function has been widely applied to people's daily life. Emergence of a wearable electronic device makes it more convenient for a user to carry and use the electronic device. An antenna that can receive/send a signal is disposed in the wearable electronic device, so that the electronic device can implement communication and positioning. However, when the user wears the wearable electronic device, a relative position between the antenna and a signal transceiver apparatus (for example, a satellite) changes in a limb swing process of the user. Consequently, communication quality and positioning precision of the antenna are affected, and user experience is degraded.

### SUMMARY

This application provides an antenna structure and an electronic device, to resolve a problem that communication quality and positioning precision are reduced because a relative position between an antenna and a signal transceiver apparatus changes.

To achieve the foregoing objective, this application uses the following technical solutions.

According to an aspect of this application, an antenna structure is provided. The antenna structure may include a ring-shaped radiator, a ground plate, a feeding end, a first ground end, a second ground end, a third ground end, and a switch assembly. The ring-shaped radiator has a preset geometric center and a first center line and a second center line that are orthogonal to each other, where the geometric center is located at an intersection point of the first center line and the second center line. The ring-shaped radiator is divided into a first semi-ring and a second semi-ring by using the preset second center line. In addition, there is a gap between the ground plate and at least a part of the ring-shaped radiator. The feeding end is disposed on the first semi-ring, and the feeding end is disposed on the first center line. The first ground end is disposed on the ring-shaped radiator, and the first ground end is coupled to the ground plate. There is a third included angle γ3 between the first center line and a connection line between the first ground end and the geometric center, γ3 ranges from −90° to +90°, and γ3 is not 0°, so that the first ground end does not overlap the feeding end. The second ground end is disposed on the second semi-ring, and the second ground end is coupled to the ground plate. There is a first included angle γ1 between the first center line and a connection line between the second ground end and the geometric center, and γ1 ranges from −60° to +60°, so that the second ground end and the feeding end more easily excite the ring-shaped radiator to operate mainly in a CM mode. In addition, the third ground end is disposed on the ring-shaped radiator, and the third ground end is coupled to the ground plate. The third ground end and the first ground end are respectively located on two sides of the first center line. In addition, there is a fourth included angle γ4 between the second center line and a connection line between the third ground end and the geometric center, and γ4 ranges from 0° to 60°. The third ground end is disposed close to the second ground end relative to the feeding end. When the third ground end is coupled to the ground plate, a ground plate current excited by the third ground end on the ground plate 202 may be superimposed with a ground plate current excited by the second ground end on the ground plate. In this way, under the joint action of the feeding end, the second ground end, and the third ground end, the ring-shaped radiator can easily operate in a symmetry mode (CM mode). In the CM mode, directivity of an electromagnetic wave radiated by the ring-shaped radiator in a 6 o'clock direction is better, and a signal is stronger. On this basis, the switch assembly is coupled between the ring-shaped radiator and the ground plate, and one end of the switch assembly is coupled to the ring-shaped radiator through the second ground end or the third ground end. When the switch assembly is turned on, the second ground end or the third ground end coupled to the switch assembly may be coupled to the ground plate.

In conclusion, according to the antenna structure provided in this embodiment of this application, when the switch assembly is in a second state, at a target frequency, at least one of the second ground end and the third ground end may be electrically isolated from the ground plate. In this case, because the first ground end is coupled to the ground plate, the feeding end and the first ground end may excite the ring-shaped radiator to operate mainly in an antisymmetry mode (DM mode). In this case, a beam direction of an electromagnetic wave radiated by the ring-shaped radiator is perpendicular to a surface of a watch face of an electronic device, for example, a smartwatch. In this case, when a user wears the electronic device, the user horizontally places his arm, so that the watch face of the watch is horizontal and faces the sky. Because a main radiation direction of the ring-shaped radiator is in a vertical direction, the beam direction of the electromagnetic wave radiated by the ring-shaped radiator is perpendicular to the surface of the watch face, and the beam direction of the electromagnetic wave faces the sky. Alternatively, when the switch assembly is in a first state, at least one of the second ground end and the third ground end, and the first ground end are electrically connected to the ground plate, so that at least one of the second ground end and the third ground end, the feeding end, and the first ground end may excite the ring-shaped radiator to be operate mainly in the CM mode. In this case, the beam direction of the electromagnetic wave radiated by the ring-shaped radiator is parallel to the surface of the watch face of the smartwatch. In this case, when the user wears the smartwatch, the user vertically places his arm, so that the watch face of the watch is vertically placed. Because the main radiation direction of the ring-shaped radiator is parallel to a direction of the watch face, the beam direction of the electromagnetic wave radiated by the ring-shaped radiator is parallel to the surface of the watch face. Therefore, the main beam direction of the electromagnetic wave of the ring-shaped radiator may face a 6 o'clock (or 9 o'clock) position and a position near the 6 o'clock (or 9 o'clock) position, and may still face the sky. In this way, when the user wears the electronic device, regardless of how the user swings his arm, that is, when the arm is horizontally placed or placed laterally during running or walking, the beam direction of the electromagnetic wave radiated by the ring-shaped radiator in the electronic device can point to the sky. Therefore, signal strength and signal transmission efficiency between the electronic device and a satellite can be improved, so that the electronic device and the satellite can perform a satellite alignment operation and signal communication, thereby improving satellite communication and positioning accuracy.

In an optional implementation, the first semi-ring and the second semi-ring may be centrosymmetrically disposed with respect to the geometric center. For example, when the ring-shaped radiator may be a circular ring or a rectangular ring, the ring-shaped radiator is a centrosymmetric pattern.

In an optional implementation, there is the first included angle γ1 between the first center line and the connection line between the second ground end and the geometric center, and γ1 ranges from −30° to +30°. In this way, the second ground end and the feeding end can more easily excite the ring-shaped radiator to operate mainly in the CM mode, the electromagnetic wave radiated by the ring-shaped radiator in the CM mode has better directivity in the 6 o'clock direction, and a signal is stronger.

In an optional implementation, there is the first included angle γ1 between the first center line and the connection line between the second ground end and the geometric center, and γ1 ranges from −15° to +15°. Similarly, the second ground end and the feeding end can more easily excite the ring-shaped radiator to operate mainly in the CM mode, the electromagnetic wave radiated by the ring-shaped radiator in the CM mode has better directivity in the 6 o'clock direction, and a signal is stronger.

In an optional implementation, on the ring-shaped radiator, a minimum physical length from the second ground end to the first center line is L1, and L1 ranges from 0 to 8.5π millimeters. In this way, when the second ground end is physically grounded or grounded through a component to the ground plate, the feeding end and the second ground end are easily enabled to excite the ring-shaped radiator to operate in the CM mode.

In an optional implementation, the second ground end may be disposed on the first center line, so that the feeding end and the second ground end are centrosymmetrically disposed with respect to the geometric center. In this way, on the ring-shaped radiator, a minimum physical length between a corresponding feeding end and the second ground end may be equal to or approximately equal to the target frequency, for example, half of a wavelength of an electromagnetic wave in an L1 frequency band of a GPS. Therefore, it is easier to enable the feeding end and the second ground end to excite the ring-shaped radiator to operate in the CM mode.

In an optional implementation, on the ring-shaped radiator, a minimum physical length from the first ground end to the feeding end is L2, and L2 ranges from 6π millimeters to 12.5π millimeters. In this way, when the first ground end is physically grounded or grounded through a component to the ground plate, the feeding end and the first ground end are easily enabled to excite the ring-shaped radiator to operate in the DM mode.

In an optional implementation, on the ring-shaped radiator, a minimum physical length from the third ground end to the second center line is L3, and L3 ranges from 0 to 8.5π millimeters. In this way, when the third ground end is physically grounded or grounded through a component to the ground plate, the feeding end, the third ground end, and the second ground end are easily enabled to excite the ring-shaped radiator to operate in the CM mode.

In an optional implementation, a preset position is disposed on the ring-shaped radiator, the ring-shaped radiator further has a third center line, the geometric center of the ring-shaped radiator and the preset position are disposed on the third center line, and the third center line is related to a radiation direction. There is a second included angle γ2 between the first center line and the third center line, where γ2 ranges from −60° to +60°. In this way, when the electronic device is the smartwatch, a display of the electronic device may display a watch face pattern. When the user wears the smartwatch, the arm of the user overlaps a part of an area of the watch face pattern, for example, an area from 2 o'clock to 4 o'clock and an area from 8 o'clock to 9 o'clock. Therefore, when a feeding end F of the antenna structure is within a range of the second included angle γ2, and the feeding end F may be disposed at a 4 o'clock position, a 5 o'clock position, a 6 o'clock position, a 7 o'clock position, or an 8 o'clock position, impact of the arm of the user on radiation signal performance of the ring-shaped radiator can be reduced.

In an optional implementation, the switch assembly includes a first switch. The first switch may be disposed between the second ground end and the ground plate, a first end of the first switch is coupled to the second ground end, and a second end of the first switch is coupled to the ground plate. When the first switch is in a first state, the second ground end is electrically connected to the ground plate at the target frequency, so that the ring-shaped radiator can operate mainly in the CM mode. In an implementation, when the first switch is in the first state, the second ground end may be physically grounded or may be grounded through a component to the ground plate. When the first switch is in a second state, the second ground end is electrically isolated from the ground plate at the target frequency. In this case, the feeding end and the third ground end may excite the ring-shaped radiator to operate in the DM mode. In an embodiment, the target frequency is a same operating frequency band, for example, the L1 frequency band of the GPS or an L5 frequency band of the GPS. A specific operating frequency band is not limited in this application.

In an optional implementation, the antenna structure further includes a first impedance network and a second impedance network. The first impedance network is disposed between the second end of the first switch and the ground plate, and the first impedance network is coupled to the second end of the first switch and the ground plate. A filter bandpass frequency of the first impedance network includes the target frequency. The second impedance network is disposed between the second ground end and the ground plate. For example, the first impedance network may implement 0 ohm grounding or component grounding of the second ground end, and the second impedance network may have an open circuit feature for the target frequency (for example, the L1 frequency band of the GPS). Alternatively, for another example, the first impedance network may have a filtering network structure with a low-pass response, so that the target frequency and a signal close to the target frequency can pass through the first impedance network. The second impedance network may include the open circuit feature for the target frequency. By disposing the impedance network, the second ground end can be grounded through a component to the ground plate.

In an optional implementation, the antenna structure further includes the first impedance network and the second impedance network. The first impedance network is disposed between the second end of the first switch and the ground plate, and the first impedance network is coupled to the second end of the first switch and the ground plate. The filter bandpass frequency of the first impedance network includes the target frequency. The second impedance network is disposed between the second ground end and the ground plate, and the second impedance network is coupled to the second ground end and the ground plate. In addition, the antenna structure may further include a third impedance network. The third impedance network is disposed between a third end of the first switch and the ground plate, and the third impedance network is coupled to the third end of the first switch and the ground plate. The first impedance network may have the filtering network structure with the low-pass response, so that the target frequency and the signal close to the target frequency can pass through the first impedance network. The third impedance network may include a device that has the open circuit feature for the target frequency. The second impedance network may have a high-pass response filtering network structure, so that a signal in a frequency band other than the target frequency, for example, the L5 frequency band of the GPS and a BT frequency band, can pass through the second impedance network. In this way, in a process in which the ring-shaped radiator switches between the L1 frequency band of the GPS in the antisymmetry mode and the L1 frequency band of the GPS in the symmetry mode, impact on signals of other frequency bands, for example, the BT frequency band and the L5 frequency band of the GPS, can be reduced.

In an optional implementation, the switch assembly further includes a third switch. The third switch is disposed between the third ground end and the ground plate, a first end of the third switch is coupled to the third ground end, and a second end of the third switch is coupled to the ground plate. A first state and a second state of the third switch are controlled, so that the electrical connection and the electrical isolation between the third ground end and the ground plate can be controlled at the target frequency. When the third switch is in the first state, the third ground end is electrically connected to the ground plate at the target frequency, so that the ring-shaped radiator can operate mainly in the CM mode. In an implementation, when the third switch is in the first state, the third ground end may be physically grounded or may be grounded through a component to the ground plate. In an implementation, in the CM mode, directivity of the electromagnetic wave radiated by the ring-shaped radiator 201 in the 6 o'clock direction is better, and a signal is stronger. When the third switch is in the second state, the third switch may be electrically isolated from the ground plate at the target frequency. In this case, the feeding end and the second ground end may excite the ring-shaped radiator to operate in the DM mode.

In an optional implementation, the antenna structure further includes the first impedance network and the second impedance network. The first impedance network is disposed between the second end of the third switch and the ground plate, and the first impedance network is coupled to the second end of the third switch and the ground plate. The filter bandpass frequency of the first impedance network includes the target frequency. The second impedance network is disposed between the third ground end and the ground plate, and the second impedance network is coupled to the third ground end and the ground plate. In addition, the antenna structure may further include a third impedance network. The third impedance network is disposed between a third end of the third switch and the ground plate, and the third impedance network is coupled to the third end of the third switch and the ground plate. Technical effect of the first impedance network, the second impedance network, and the third impedance network are the same as those described above. Details are not described herein again.

In an optional implementation, the antenna structure further includes a second switch. The second switch is disposed between the first ground end and the ground plate, a first end of the second switch is coupled to the first ground end, and a second end of the second switch is coupled to the ground plate. The second end of the second switch may be directly coupled to the ground plate. At the target frequency, when the second switch is in a first state, the ring-shaped radiator may be physically grounded through the second switch. Alternatively, for another example, an impedance network may be disposed between the second end of the second switch and the ground plate. At the target frequency, when the second switch is in the first state, the ring-shaped radiator may implement grounding through a component by using the impedance network. Alternatively, when the second switch is in a second state, the first ground end is electrically isolated from the ground plate at the target frequency.

In an optional implementation, the antenna structure further includes a fourth ground end, the fourth ground end is disposed on the ring-shaped radiator and is located between the first ground end and the second ground end, and the fourth ground end is coupled to the ground plate. In this way, the fourth ground end is disposed, so that when the first ground end is coupled to the ground plate and the ring-shaped radiator operates in the DM mode, a frequency of a signal radiated by the ring-shaped radiator can be adjusted, so that the frequency of the signal radiated by the ring-shaped radiator is the target frequency. Alternatively, in comparison with a solution in which the fourth ground end is not disposed, the frequency of the signal radiated by the ring-shaped radiator is closer to the target frequency.

In an optional implementation, there is a fifth included angle γ5 between the second center line and a connection line between the fourth ground end and the geometric center, and γ5 ranges from −60° to +60°. In this way, when the fourth ground end is disposed at any point on the ring-shaped radiator within a range of the fifth included angle γ5, and the fourth ground end is physically grounded or grounded through a component to the ground plate, the frequency of the signal radiated by the ring-shaped radiator is more likely to reach the target frequency.

In an optional implementation, on the ring-shaped radiator, a minimum physical length from the fourth ground end to the second center line is L4, and L4 ranges from 0 to 8.5π millimeters. Technical effect of a size range of L4 is the same as technical effect of a setting range of the fourth included angle γ4. Details are not described herein again.

In an optional implementation, the antenna structure further includes a fourth switch. The fourth switch is disposed between the fourth ground end and the ground plate, a first end of the fourth switch is coupled to the fourth ground end, and a second end of the fourth switch is coupled to the ground plate. A first state and a second state of the fourth switch are controlled, so that the fourth ground end may be controlled to be electrically connected to and electrically isolated from the ground plate at the target frequency.

In an optional implementation, no slot is disposed in the ring-shaped radiator. The ring-shaped radiator may be a complete ring-shaped conductor. The ring-shaped radiator may be a ring-shaped conductive structure with a closed head and tail.

In an optional implementation, a slot is disposed in the ring-shaped radiator, and the slot and the first ground end are respectively located on the two sides of the first center line. In this way, the slot is disposed, so that the ring-shaped radiator can more easily excite the CM mode when the second ground end is coupled to the ground plate.

In an optional implementation, there is a sixth included angle γ6 between the second center line and a connection line between the geometric center and a geometric center of the slot, and γ6 ranges from −30° to +30°. In this way, when the slot is disposed in the sixth included angle γ6, the slot may be disposed in a large current area. This is more conducive to excitation of the CM mode of the ring-shaped radiator. In addition, when the second ground end is coupled to the ground plate, and at the target frequency, when both the first ground end and the third ground end are electrically isolated from the ground plate, the ring-shaped radiator operates mainly in the CM mode. In this case, the beam direction of the electromagnetic wave radiated by the ring-shaped radiator is parallel to the surface of the watch face of the smartwatch. In this case, when the user wears the smartwatch in the left hand and the arm naturally drops (for example, the user is in a walking state), the beam direction of the electromagnetic wave radiated by the ring-shaped radiator is parallel to the surface of the watch face. Therefore, a main beam direction of the electromagnetic wave of the ring-shaped radiator may face a 9 o'clock position and a position near the 9 o'clock position, and may still face the sky. Alternatively, at the target frequency, when the third ground end is electrically isolated from the ground plate, and both the second ground end and the first ground end may be coupled to the ground plate, the ring-shaped radiator operates mainly in the DM mode. The beam direction of the electromagnetic wave radiated by the ring-shaped radiator is perpendicular to the surface of the watch face of the smartwatch. In this case, when the arm of the user is horizontally placed, so that the watch face of the watch is horizontal and faces the sky, the beam direction of the electromagnetic wave radiated by the ring-shaped radiator is perpendicular to the surface of the watch face, and the beam direction of the electromagnetic wave faces the sky. Alternatively, at the target frequency, when the first ground end is electrically isolated from the ground plate, and both the third ground end and the second ground end may be coupled to the ground plate, the ring-shaped radiator operates mainly in the CM mode. In this case, when the user wears the electronic device, the user vertically places his arm, so that the watch face of the watch is vertically placed. The beam direction of the electromagnetic wave radiated by the ring-shaped radiator is parallel to the surface of the watch face. Therefore, the main beam direction of the electromagnetic wave of the ring-shaped radiator may face the 6 o'clock position and a position near the 6 o'clock position, and may still face the sky. In this way, regardless of how the user swings his arm, the beam direction of the electromagnetic wave radiated by the ring-shaped radiator in the electronic device can point to the sky, thereby improving satellite communication and positioning accuracy. Alternatively, in some other embodiments of this application, there is a seventh included angle γ7 between the first center line and a connection line between the geometric center and the geometric center of the slot, and γ7 ranges from −30° to +30°. In this way, when the slot is disposed in the sixth included angle γ6 or the seventh included angle γ7, the slot may be disposed in a large current area. This is more conducive to excitation of the CM mode of the ring-shaped radiator.

In an optional implementation, on the ring-shaped radiator, a minimum physical length from the slot to the second center line is L5, and L5 ranges from 3π to 4.5π millimeters. Alternatively, on the ring-shaped radiator, a minimum physical length from the slot to the first center line is L6, and L6 ranges from 3π to 4.5π millimeters. Technical effect of a size range of L5 is the same as technical effect of a setting range of the fifth included angle γ5, and technical effect of a size range of L6 is the same as technical effect of a setting range of the sixth included angle γ6. Details are not described herein again.

In an optional implementation, frequencies of the antenna structure include the L1 frequency band and the L5 frequency band of a global positioning system, and a Bluetooth frequency band. The example L1 frequency band may be used as the target frequency for antenna mode switching.

In an optional implementation, the antenna structure further includes a feed and an impedance network disposed between the feed and the feeding end. The impedance network may be electrically connected to the feed and the feeding end, to perform impedance matching.

In an optional implementation, a horizontal spacing between the ring-shaped radiator and the ground plate may be 0.5 mm to 0.9 mm, to meet a clearance requirement of the antenna.

According to another aspect of this application, an antenna structure is provided. The antenna structure may include a ring-shaped radiator, a ground plate, a feeding end, a second ground end, a third ground end, and a switch assembly. The ring-shaped radiator has a preset geometric center and a first center line and a second center line that are orthogonal to each other. The geometric center is located at an intersection point of the first center line and the second center line. The ring-shaped radiator is divided into a first semi-ring and a second semi-ring by using the preset second center line. There is a gap between the ground plate and at least a part of the ring-shaped radiator. The feeding end is disposed on the first semi-ring, and the feeding end is disposed on the first center line. The second ground end is disposed on the second semi-ring, and the second ground end is coupled to the ground plate. There is a first included angle γ1 between the first center line and a connection line between the second ground end and the geometric center, and γ1 ranges from −15° to +15°. The third ground end is disposed on the ring-shaped radiator, and the third ground end is coupled to the ground plate. There is a fourth included angle γ4 between the second center line and a connection line between the third ground end and the geometric center, and γ4 ranges from 0° to 60°. The third ground end is disposed close to the second ground end relative to the feeding end. In addition, the switch assembly is coupled between the ring-shaped radiator and the ground plate, and one end of the switch assembly is coupled to the ring-shaped radiator through the second ground end or the third ground end. The antenna structure has same technical effect as the antenna structure provided in the foregoing embodiments. Details are not described herein again. In addition, because γ1 ranges from −15° to +15°, the second ground end and the feeding end may be basically located at opposite positions on the ring-shaped radiator, so that a directivity coefficient of an electromagnetic wave radiated by the ring-shaped radiator in a CM mode is larger, and signal strength is higher.

In an optional implementation, a minimum physical length from the second ground end to the first center line is L1, and L1 ranges from 0 to 2π millimeters. Technical effect of a size range of the minimum physical length L1 is the same as technical effect of a setting range of the first included angle γ1. Details are not described herein again.

In an optional implementation, the second ground end may be disposed on the first center line, so that the feeding end and the second ground end are centrosymmetrically disposed with respect to the geometric center. Technical effect of disposing the second ground end on the first center line is the same as that described above. Details are not described herein again.

In an optional implementation, on the ring-shaped radiator, a minimum physical length from the third ground end to the second center line is L3, and L3 ranges from 0 to 8.5π millimeters. Technical effect of a size range of L3 is the same as that described above. Details are not described herein again.

In an optional implementation, the preset position is disposed on the ring-shaped

radiator, the ring-shaped radiator further has a third center line, the geometric center of the ring-shaped radiator and the preset position are disposed on the third center line, and the third center line is related to a radiation direction. There is a second included angle γ2 between the first center line and the third center line, where γ2 ranges from −60° to +60°. Technical effect of the second included angle γ2 is the same as that described above, and details are not described herein again.

In an optional implementation, the switch assembly includes a first switch. The first switch may be disposed between the second ground end and the ground plate, a first end of the first switch is coupled to the second ground end, and a second end of the first switch is coupled to the ground plate. Technical effect of the first switch is the same as that described above, and details are not described herein again.

In an optional implementation, the switch assembly includes a third switch. The third switch is disposed between the third ground end and the ground plate, a first end of the third switch is coupled to the third ground end, and a second end of the third switch is coupled to the ground plate. Technical effect of the first switch is the same as that described above, and details are not described herein again.

In an optional implementation, no slot is disposed in the ring-shaped radiator. The ring-shaped radiator may be a complete ring-shaped conductor. The ring-shaped radiator may be a ring-shaped conductive structure with a closed head and tail. In an optional implementation, a slot is disposed in the ring-shaped radiator, there is a sixth included angle γ6 between the second center line and a connection line between the slot and the geometric center, and γ6 ranges from −30° to +30°. Alternatively, on the ring-shaped radiator, a minimum physical length from the slot to the second center line is L5, and L5 ranges from 3π to 4.5π millimeters. Technical effect of the slot is the same as that described above. Details are not described herein again.

In an optional implementation, the antenna structure further includes a first ground end, the first ground end is disposed on the ring-shaped radiator, and the first ground end is coupled to the ground plate. There is a third included angle γ3 between the first center line and a connection line between the first ground end and the geometric center, γ3 ranges from −90° to +90°, and γ3 is not 0°, so that the first ground end does not overlap the feeding end. Technical effect of the first ground end is the same as that described above. Details are not described herein again.

In an optional implementation, the antenna structure further includes a second switch. The second switch is disposed between the first ground end and the ground plate, a first end of the second switch is coupled to the first ground end, and a second end of the second switch is coupled to the ground plate. Technical effect of the second switch is the same as that described above. Details are not described herein again.

According to another aspect of this application, an antenna structure is provided. The antenna structure includes a ring-shaped radiator, a ground plate, a feeding end, a first ground end, a second ground end, and a first switch. The ring-shaped radiator has a preset geometric center and a first center line and a second center line that are orthogonal to each other. The geometric center is located at an intersection point of the first center line and the second center line. The ring-shaped radiator is divided into a first semi-ring and a second semi-ring by using the preset second center line. There is a gap between the ground plate and at least a part of the ring-shaped radiator. The feeding end is disposed on the first semi-ring, and the feeding end is disposed on the first center line. The first ground end is disposed on the ring-shaped radiator, and the first ground end is coupled to the ground plate. The second ground end is disposed on the second semi-ring. The first switch is disposed between the second ground end and the ground plate, a first end of the first switch is coupled to the second ground end, and a second end of the first switch is coupled to the ground plate. In addition, when the first switch is in a second state, current flow directions between two adjacent current zero points of a current that is distributed on the ring-shaped radiator are the same. When the first switch is in a first state, current flow directions between two adjacent current zero points of a current that is distributed on the ring-shaped radiator are opposite. When the first switch is in the first state and the second state, the current distributed on the ring-shaped radiator enables the antenna structure to operate at a target frequency. The antenna structure has the same technical effect as the antenna structure provided in the foregoing embodiments. Details are not described herein again.

In an optional implementation, there is the first included angle γ1 between the first center line and the connection line between the second ground end and the geometric center, and γ1 ranges from −60° to +60°. Technical effect of the first included angle γ1 is the same as that described above. Details are not described herein again.

In an optional implementation, on the ring-shaped radiator, a minimum physical length from the second ground end to the first center line is L1, and L1 ranges from 0 to 8.5π millimeters. Technical effect of a size range of L1 is the same as that described above. Details are not described herein again.

In an optional implementation, there is a third included angle γ3 between the first center line and a connection line between the first ground end and the geometric center, γ3 ranges from −90° to +90°, and the first ground end does not overlap the feeding end. Technical effect of the third included angle γ3 is the same as that described above. Details are not described herein again.

In an optional implementation, on the ring-shaped radiator, a minimum physical length from the first ground end to the feeding end is L2, and L2 ranges from 6π millimeters to 12.5π millimeters. Technical effect of a size range of L2 is the same as that described above. Details are not described herein again.

According to another aspect of this application, an electronic device is provided. The electronic device includes a cover plate, a rear cover, and any antenna structure described above. The antenna structure is disposed between the cover plate and the rear cover, and a ring-shaped radiator of the antenna structure is used as at least a part of a frame of the electronic device. The electronic device has same technical effect as the antenna structure provided in the foregoing embodiment. Details are not described herein again.

In an optional implementation, the electronic device further includes a circuit board. In a thickness direction of the electronic device, the circuit board and the frame are at least partially staggered. The frame is disposed close to the cover plate relative to the circuit board. The thickness direction is a direction pointing from the rear cover to the cover plate. In this way, a distance between the circuit board and the frame can be increased, and when at least a part of the frame is used as a radiator for receiving and sending a signal, radiation clearance of the radiator can be increased.

In an optional implementation, the electronic device further includes a display. The display is disposed between the rear cover and the cover plate, a display surface of the display faces the cover plate, and the display surface is configured to display a watch face pattern. Due to a limitation of layout space of a component in a smartwatch, a vertical projection of a 5 o'clock position in the watch face pattern on the rear cover, a vertical projection of a feeding end of the antenna structure on the rear cover, and a geometric center of the watch face pattern are collinear. Therefore, the feeding end may be disposed at the 5 o'clock position in the watch face pattern. A vertical projection of an 11 o'clock position or a 1 o'clock position in the watch face pattern on the rear cover, a vertical projection of a second ground end of the antenna structure on the rear cover, and the geometric center of the watch face pattern are collinear. Therefore, the second ground end may be disposed at the 11 o'clock position or the 1 o'clock position in the watch face pattern.

In an optional implementation, the antenna structure includes a first ground end and a third ground end, the first ground end is disposed on the ring-shaped radiator, and the first ground end is coupled to the ground plate. The third ground end is disposed on the ring-shaped radiator, the third ground end and the first ground end are respectively located on two sides of a first center line, and the third ground end is coupled to the ground plate of the antenna structure. A vertical projection of a 7 o'clock position or an 8 o'clock position in the watch face pattern on the rear cover, a vertical projection of the first ground end of the antenna structure on the rear cover, and the geometric center of the watch face pattern are collinear. When the vertical projection of the 11 o'clock position in the watch face pattern on the rear cover, the vertical projection of the second ground end of the antenna structure on the rear cover, and the geometric center of the watch face pattern are collinear, due to a limitation of layout space of a component in the smartwatch, the vertical projection of the 1 o'clock position in the watch face pattern on the rear cover, a vertical projection of the third ground end on the rear cover, and the geometric center of the watch face pattern are collinear. Therefore, the third ground end is disposed at the 1 o'clock position in the watch face pattern.

In an optional implementation, the antenna structure further includes a fourth ground end, the fourth ground end is disposed on the ring-shaped radiator, and the fourth ground end is coupled to the ground plate. The fourth ground end and the third ground end are respectively located on the two sides of the first center line. When a vertical projection of a 7 o'clock position in the watch face pattern on the rear cover, the vertical projection of the first ground end of the antenna structure on the rear cover, and the geometric center of the watch face pattern are collinear, due to the limitation of the layout space of the component in the smartwatch, a vertical projection of an 8 o'clock position in the watch face pattern on the rear cover, a vertical projection of the fourth ground end on the rear cover, and the geometric center of the watch face pattern are collinear. Therefore, the fourth ground end is disposed at the 8 o'clock position in the watch face pattern.

In an optional implementation, a slot is disposed in the ring-shaped radiator. When the vertical projection of the 11 o'clock position in the watch face pattern on the rear cover, the vertical projection of the second ground end of the antenna structure on the rear cover, and the geometric center of the watch face pattern are collinear, a vertical projection of the 1 o'clock position or a 4 o'clock position in the watch face pattern on the rear cover, a vertical projection of the slot of the antenna structure on the rear cover, and the geometric center of the watch face pattern that are collinear. In this way, the slot of the antenna structure is disposed at the 1 o'clock position or the 4o'clock position in the watch face pattern. In this way, the slot may be disposed in a large current area. This is more conducive to excitation of an antisymmetry mode of the ring-shaped radiator.

In an optional implementation, the electronic device further includes a display. The display is disposed between the rear cover and the cover plate, a display surface of the display faces the cover plate, and the display surface is configured to display a watch face pattern. A vertical projection of a 7 o'clock position in the watch face pattern on the rear cover, a vertical projection of a feeding end of the antenna structure on the rear cover, and a geometric center of the watch face pattern are collinear. Therefore, the feeding end is disposed at the 7 o'clock position in the watch face pattern. A vertical projection of a 1 o'clock position in the watch face pattern on the rear cover, a vertical projection of a second ground end of the antenna structure on the rear cover, and the geometric center of the watch face pattern are collinear. Therefore, the second ground end is disposed at the 1 o'clock position in the watch face pattern.

In an optional implementation, a contour shape of the ring-shaped radiator may be a circular ring, a rectangular ring, or the like. The contour shape of the ring-shaped radiator may match a contour shape of the display in the electronic device.

### BRIEF DESCRIPTION OF DRAWINGS

FIG. 1 is a diagram of a structure of an electronic device according to an embodiment of this application;

FIG. 2A is a diagram of a structure of an antenna structure according to an embodiment of this application;

FIG. 2B is a diagram of a preset geometric center, a first center line, and a second center line of a ring-shaped radiator in FIG. 2A;

FIG. 2C is a diagram of a structure of a ground plate in FIG. 2B;

FIG. 3 is a corresponding waveform diagram of an antenna echo according to an embodiment of this application;

(a1), (b1), (c1), (d1), (e1), and (f1) in FIG. 4 are current distribution diagrams of antennas in different wavelength modes according to an embodiment of this application, and (a2), (b2), (c2), (d2), (e2), and (f2) are antenna patterns in different wavelength modes according to an embodiment of this application;

FIG. 5A is a current curve diagram of an antenna shown in FIG. 2C;

FIG. 5B is a planar antenna pattern shown in FIG. 2C;

FIG. 6A is a diagram of a state in which a user wears an electronic device according to an embodiment of this application;

FIG. 6B is a three-dimensional antenna pattern shown in FIG. 2C;

FIG. 7A is a diagram of a structure of another antenna structure according to an embodiment of this application;

FIG. 7B is a diagram of a structure of a ground plate in FIG. 7A;

FIG. 8A is a current distribution diagram of an antenna shown in FIG. 7B;

FIG. 8B is a current waveform diagram of an antenna shown in FIG. 7B;

FIG. 8C is a three-dimensional antenna pattern shown in FIG. 7B;

FIG. 8D is a planar antenna pattern shown in FIG. 7B;

FIG. 9A is a diagram of another state in which a user wears an electronic device according to an embodiment of this application;

FIG. 9B is a three-dimensional antenna pattern according to an embodiment of this application;

FIG. 9C is an enlarged view of a position C in FIG. 9A;

FIG. 10A is a sectional view at a position 1 in FIG. 9B;

FIG. 10B is a sectional view at a position 2 in FIG. 9B;

FIG. 10C is a sectional view at a position 3 in FIG. 9B;

FIG. 11A is a diagram of a structure of still another antenna structure according to an embodiment of this application;

FIG. 11B is a diagram of a structure of yet another antenna structure according to an embodiment of this application;

FIG. 12 is a diagram of a structure of still yet another antenna structure according to an embodiment of this application;

FIG. 13A is a diagram of another manner of disposing a feeding end and a ground end of an antenna according to an embodiment of this application;

FIG. 13B is a diagram of another manner of disposing a feeding end and a ground end of an antenna according to an embodiment of this application;

FIG. 14 is a curve diagram of an antenna return loss and antenna system efficiency in different modes according to an embodiment of this application;

FIG. 15 is a diagram of a manner of disposing a feeding end and a ground end of an antenna according to an embodiment of this application;

FIG. 16A is a diagram of an implementation structure, in an entire device, of a ground plate in a simple model shown in FIG. 12;

FIG. 16B is a diagram of a manner of disposing a feeding end and a ground end of an antenna based on a ground plate structure in FIG. 16A;

FIG. 17 is a diagram of still another manner of disposing a feeding end and a ground end of an antenna according to an embodiment of this application;

FIG. 18 is a diagram of a manner of disposing a feeding end and a ground end in a smartwatch according to an embodiment of this application;

FIG. 19 is a diagram of wearing an electronic device according to an embodiment of this application;

FIG. 20 is a diagram of another manner of disposing a feeding end and a ground end in a smartwatch according to an embodiment of this application;

FIG. 21 is a diagram of still another manner of disposing a feeding end and a ground end in a smartwatch according to an embodiment of this application;

FIG. 22A is a diagram of yet another manner of disposing a feeding end and a ground end of an antenna according to an embodiment of this application;

FIG. 22B is a diagram of still yet another manner of disposing a feeding end and a ground end of an antenna according to an embodiment of this application;

FIG. 22C is a current distribution diagram of an electronic device shown in FIG. 22A;

FIG. 22D is a current distribution diagram of an electronic device shown in FIG. 22A;

FIG. 23A is a diagram of further another manner of disposing a feeding end and a ground end of an antenna according to an embodiment of this application;

FIG. 23B is a diagram of further another manner of disposing a feeding end and a ground end of an antenna according to an embodiment of this application;

FIG. 23C is a diagram of yet another manner of disposing a feeding end and a ground end in a smartwatch according to an embodiment of this application;

FIG. 24A is a diagram of still yet another manner of disposing a feeding end and a ground end in a smartwatch according to an embodiment of this application;

FIG. 24B is a diagram of a disposing manner in which a ground end is coupled to a ground plate in FIG. 24A;

FIG. 25A is a diagram of an equivalent structure in which a switch in FIG. 24B is controlled to be in a first state and a second state;

FIG. 25B is another diagram of wearing an electronic device according to an embodiment of this application;

FIG. 26A is a diagram of an equivalent structure in which a switch in FIG. 24A is controlled to be in a first state and a second state;

FIG. 26B is a diagram of another equivalent structure in which a switch in FIG. 24A is controlled to be in a first state and a second state;

FIG. 27 is a diagram of further another manner of disposing a feeding end and a ground end in a smartwatch according to an embodiment of this application;

FIG. 28 is a diagram of further another manner of disposing a feeding end and a ground end in a smartwatch according to an embodiment of this application; and

FIG. 29 is a diagram of further another manner of disposing a feeding end and a ground end in a smartwatch according to an embodiment of this application.

### REFERENCE NUMERALS

01: electronic device; 10: display; 11: frame; 12: rear cover; 13: cover plate; 14: circuit board; 20: antenna structure; 201 ring-shaped radiator; 202: ground plate; 2011: first semi-ring; 2012: second semi-ring; F: feeding end; G1: first ground end; G2: second ground end; 100: arm; P: preset position; 211: first part; 212: second part; 200: watch face pattern; 31: first impedance network; 32: second impedance network; 33: third impedance network; G3: third ground end; 213: third part; 40: impedance network; G4: fourth ground end; 214: fourth part; and 300: switch assembly.

### DESCRIPTION OF EMBODIMENTS

The following describes the technical solutions in embodiments of this application with reference to the accompanying drawings in embodiments of this application. It is clear that the described embodiments are merely a part rather than all of embodiments of this application. When describing a single assembly, apparatus, or system, a plurality of such assemblies, apparatuses, or systems may perform related functions. For example, one or more processors may perform function descriptions related to one processor.

The terms such as “first” and “second” below are merely intended for convenience of description, and cannot be construed as indicating or implying relative importance or implicitly indicating a quantity of indicated technical features. Therefore, a feature limited by “first”, “second”, or the like may explicitly or implicitly include one or more features. In the descriptions of this application, unless otherwise stated, “a plurality of” means two or more than two.

Limitations such as collinear, symmetric (for example, axisymmetric or centrosymmetric), parallel, vertical, orthogonal, and same (for example, a same length and a same width) mentioned in embodiments of this application are all for a current process level, and are not absolutely-strict definitions in mathematics. Collinearity of the three elements may be understood as that a connection line or an extension line of two elements has an intersection point with the other element, or a shortest distance between the connection line or the extension line and the other element is about 2 mm. In an embodiment, the collinear element may include, for example, a mechanical part that implements a “feeding end” or a “ground end” for example, a protruding structure, a spring, or a spring plate on an inner surface of a conductive frame. There may be a deviation of a predetermined angle between two components that are parallel or perpendicular to each other. In an embodiment, the predetermined threshold may be less than or equal to a threshold of 1 mm. For example, the predetermined threshold may be 0.5 mm, or may be 0.1 mm. In an embodiment, the predetermined angle may be an angle within a range of +10°, for example, a deviation of the predetermined angle is +5°.

In this application, unless otherwise clearly specified and limited, a term “connection” should be understood in a broad sense. For example, the “connection” may be a fixed mechanical connection, or may be a detachable mechanical connection or an integrated connection, or may be a direct connection or an indirect connection implemented through an intermediate medium.

In addition, unless otherwise specified and limited, the term “coupling” should be understood in a broad sense. For example, “coupling” may be a direct electrical connection, for example, two components are in physical contact and electrically connected, and may also be understood that different components in a line structure are electrically connected by using a physical line that can transmit an electrical signal, such as a printed circuit board (printed circuit board, PCB) copper foil or a conducting wire, to transmit the electrical signal. Alternatively, “coupling” may be an indirect electrical connection between two components through an intermediate medium. Alternatively, “coupling” may be an electrical connection between two components in a space-free/non-contact manner. For example, the two components are electrically connected in a capacitive coupling manner, to transmit the electrical signal.

In the accompanying drawings of embodiments of this application, an assembly is represented by using a guide line with an arrow, and a component is represented by using only a guide line.

The technical solutions provided in embodiments of this application are applicable to an electronic device using one or more of the following communication technologies. The communication protocol may include a Bluetooth (blue-tooth, BT) communication technology, a global positioning system (global positioning system, GPS) communication technology, a global system for mobile communication (global system of mobile communication, GSM) communication technology, a wireless fidelity (wireless fidelity, Wi-Fi) communication technology, a wideband code division multiple access (wideband code division multiple access wireless, WCDMA) communication technology, long term evolution (long term evolution, LTE), a 5G communication technology, another future communication technology, and the like. The electronic device in embodiments of this application may be a mobile phone (mobile phone), a tablet computer (pad), a laptop, a smart home, a smart wearable device (for example, a smartwatch, a smart band, smart glasses, or a smart helmet), a virtual reality (virtual reality, VR) electronic device, an augmented reality (augmented reality, AR) electronic device, or the like. Alternatively, the electronic device may be a handheld device that has a wireless communication function, a computing device, another processing device connected to a wireless modem, a vehicle-mounted device, an electronic device in a 5G network, an electronic device in a future evolved public land mobile network (public land mobile network, PLMN), or the like. This is not limited in embodiments of this application.

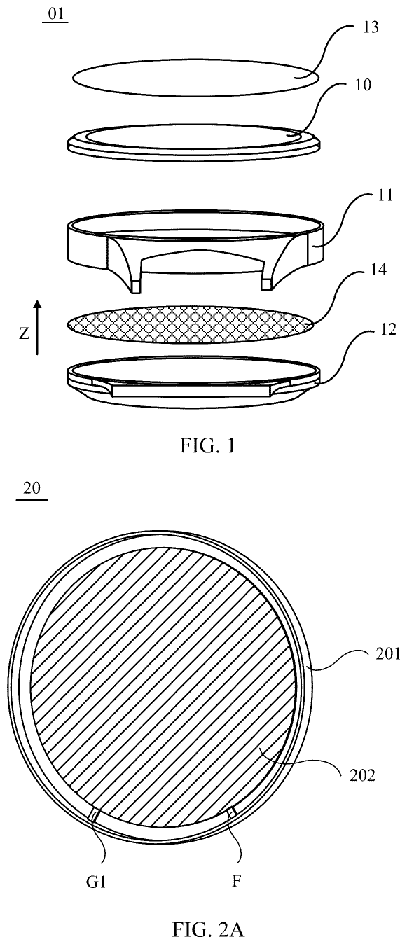

For ease of description, the following uses an example in which an electronic device 01 shown in FIG. 1 is a smartwatch for description. For example, the electronic device 01 may include a display (display) 10, a frame 11, and a rear cover (rear cover) 12. The display 10 may be disposed in the frame 11, a display surface of the display 10 is located on a side facing away from the rear cover 12, and the frame 11 may be disposed around the display 10. The display 10 may be a liquid crystal display (liquid crystal display, LCD), an organic light emitting diode (organic light emitting diode, OLED) display, or a micro (micro or mini) light emitting diode (light emitting diode, LED) display.

To protect the display 10, the electronic device 01 may further include a cover plate (cover plate) 13 that covers the display surface of the display 10, and the cover plate 13 may be made of a transparent material. A shape of the display 10 is not limited in this application. For example, the display surface of the display 10 may be a circle or a rectangle. Contour shapes of the cover plate 13, the frame 11, and the rear cover 12 may match a contour shape of the display 10. For ease of description, the following uses an example in which the contour shapes of the display 10, the cover plate 13, the frame 11, and the rear cover 12 are circular for description.

In addition, the electronic device 01 may further include a circuit board 14 shown in FIG. 1, for example, a printed circuit board (printed circuit board, PCB). In a thickness direction (a direction Z in FIG. 1) of the electronic device 01, the circuit board 14 and the frame 11 are at least partially staggered. For example, the frame 11 may be disposed close to the cover plate 13 relative to the circuit board 14, that is, the frame 11 may be located above the circuit board 14, so that a distance between the circuit board 14 and the frame 11 can be increased, and when at least a part of the frame 11 is used as a radiator for receiving/sending a signal, radiation clearance of the radiator can be increased. The thickness direction (the direction Z in FIG. 1) may be a direction pointing from the rear cover 12 to the cover plate 13.

On this basis, the electronic device 01 may further include components such as a battery, a processor, a sensor, a microphone, and a speaker. In some embodiments of this application, components such as the circuit board 14, the battery, the processor, the sensor, the microphone, and the speaker may be disposed between the display 10 and the rear cover 12. The frame 11 may support the entire electronic device 01. In some embodiments of this application, the cover plate 13 and the rear cover 12 cover each other along an upper edge and a lower edge of the frame 11 respectively, to form a casing or a housing (housing) of the electronic device 01. Alternatively, the frame 11 and the rear cover 12 may be connected to form an integrally formed part, and the cover plate 13 is connected to the integrally formed part, to form the casing or the housing of the electronic device 01. It should be understood that the “casing or housing” may be used to refer to a part or all of any one of the cover plate 13, the rear cover 12, or the frame 11, or refer to a part or all of any combination of the cover plate 13, the rear cover 12, or the frame 11.

For example, the frame 11 may be made of a conductive material such as metal, and the frame 11 made of the metal material may form an appearance of a metal frame. Alternatively, for another example, the frame 11 may be made of a metal material and a non-metal material. In addition, a material of the rear cover 12 may include a non-conductive material, for example, plastic or glass, or the rear cover 12 may include a conductive metal material and a non-metal material. After the frame 11 is connected to the rear cover 12, a part that is of the frame 11 and that is made of the conductive material may be insulated from a part that is of the rear cover 12 and that is made of the conductive material.

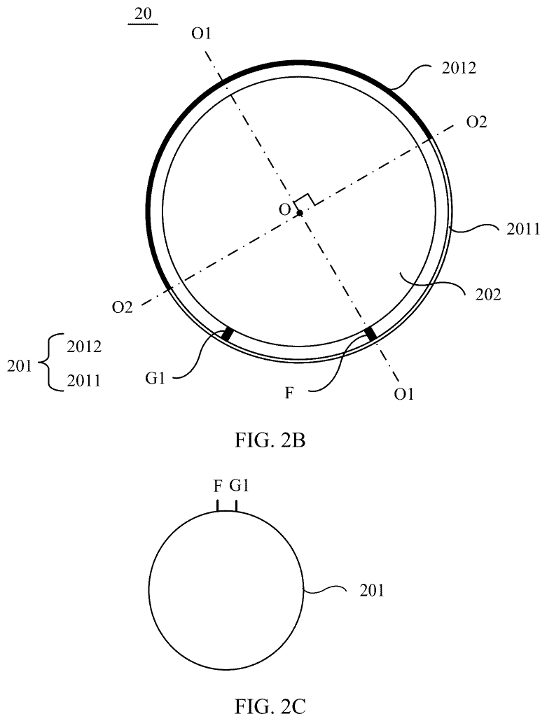

Based on this, in some embodiments of this application, the electronic device 01 further includes an antenna structure 20 shown in FIG. 2A. The antenna structure 20 may include a ring-shaped radiator 201, a ground plate 202, a feeding end F, and a ground end, for example, a first ground end G1.

In an embodiment, the ground plate 202 shown in FIG. 2A may include the circuit board 14 in FIG. 1, and specifically, may include a metal layer in the circuit board 14. In an embodiment, the ground plate 202 may further include a battery and/or another grounded mechanical part, a grounded component, and the like. It should be understood that the ground plate 202 may have an irregular shape. In an embodiment, the ground plate 202 (for example, including the circuit board 14) may have a structure that is generally I-shaped, L-shaped, or U-shaped, to spare specific space for placing another mechanical part and/or component inside the electronic device 01. In an embodiment, the ground plate 202 (for example, including the circuit board 14) may also have a structure that is generally circular, square, or rectangular, to facilitate grounding of the mechanical part and/or the component in the electronic device.

In an embodiment, a gap is disposed between the ground plate 202 and at least a part of the ring-shaped radiator 201 in the electronic device 01, to provide radiation clearance of a radiator. For example, a horizontal spacing between the ring-shaped radiator 201 and the ground plate 202 may range from 0.5 mm to 0.9 mm. In an embodiment, a coupling structure is disposed between the ground plate 202 and the ring-shaped radiator 201 to provide grounding of the radiator. It should be understood that an antenna formed by using the ring-shaped radiator 201 may operate in different antenna modes. When a large ground plate current is excited in an antenna mode, a shape and a size of the ground plate 202 greatly affect performance of the antenna mode. When a small ground plate current is induced in an antenna mode, the shape and the size of the ground plate 202 basically do not affect performance of the antenna mode.

In embodiments of this application, the radiator is an apparatus that is in the antenna structure 20 and that is configured to receive/send electromagnetic wave radiation. In some cases, an “antenna” is understood as a radiator in a narrow sense. The antenna converts guided wave energy from a transmitter into a radio wave, or converts a radio wave into guided wave energy to radiate and receive a radio wave. Modulated high-frequency current energy (or guided wave energy) generated by the transmitter is transmitted to a transmitting radiator through a feeder. The radiator converts the energy into specific polarized electromagnetic wave energy and radiates the energy in a required direction. A receiving radiator converts the specific polarized electromagnetic wave energy from a specific direction of space into modulated high-frequency current energy, and transmits the modulated high-frequency current energy to an input end of a receiver through a feeder.

The feeding end F and the ground end (including the first ground end G1 and a second ground end G2) may be considered as a section of radiator that is coupled to a feeding circuit (not shown in the figure) and the ground plate 202 and that is of the ring-shaped radiator 201. The “end” cannot be understood in a narrow sense as an endpoint or an end part that is physically disconnected from another radiator, or may be considered as a point or a segment on a continuous radiator. In an embodiment, the “end” may include a coupling area in which another conductive structure is coupled to the antenna radiator. For example, the feeding end may be a connection area that is on the antenna radiator and that is coupled to or is connected through coupling to a part of the feeding circuit (for example, an area facing the part of the feeding circuit).

For example, when the frame 11 shown in FIG. 1 includes a metal conductive material, at least a part of the frame 11 may be used as the ring-shaped radiator 201. For example, a metal conductive part in the frame 11 may be disposed around the display 10 to form the ring-shaped radiator 201 shown in FIG. 2A.

For example, when the frame 11 shown in FIG. 1 includes a non-conductive material, the radiator 201 in a ring shape may be disposed on an inner side of the frame 11. For example, the radiator 201 may be closely attached to an inner surface of the frame 11, or may be spaced from the inner surface of the frame 11.

Alternatively, for another example, the ring-shaped radiator 201 may be in an antenna form such as an antenna form based on a flexible printed circuit (flexible printed circuit, FPC), an antenna form based on laser direct structuring (laser direct structuring, LDS), or an antenna form of a micro strip disk antenna (micro strip disk antenna, MDA).

A manner of disposing the ring-shaped radiator 201 is not limited in this application. For ease of description, the following provides descriptions by using an example in which the metal conductive part in the frame 11 shown in FIG. 1 may be disposed around the display 10 to form the ring-shaped radiator 201 shown in FIG. 2A. For example, a contour shape of the ring-shaped radiator 201 may be a circular ring shown in FIG. 2A, or may be a rectangular ring or a polygonal ring. This is not limited in this application. For ease of description, the following uses an example in which the ring-shaped radiator 201 is a circular ring for description.

On this basis, when the ground end (for example, the first ground end G1) in the antenna structure 20 shown in FIG. 2A is coupled to the ground plate 202, the ring-shaped radiator 201 may be grounded (GND). Grounding means coupling to the ground plate 202 (or the ground) in any manner. In an embodiment, grounding may be physical grounding. For example, a specific position on the ring-shaped radiator 201 is physically grounded (or referred to as physical grounding) through some mechanical parts of the ring-shaped radiator 201. In an embodiment, grounding may be grounding via a component, for example, grounding by connecting a component (or referred to as component grounding) like a capacitor/inductor/resistor in series or in parallel. The capacitor/inductor/resistor or the like connected in series or in parallel may be referred to as an impedance network. The impedance network may perform at least one of impedance matching and filtering on the antenna.

Impedance of the antenna is usually a ratio of a voltage to a current at an input end of the antenna. Antenna impedance is a measure of a resistance of an antenna to an electrical signal. A main purpose of impedance matching of the antenna is to implement matching between the antenna and a transmission line. When the antenna matches the transmission line, power transmitted from a transmitter to the antenna or from the antenna to a receiver is maximum. In this case, no reflected wave appears on the transmission line, a reflection coefficient is equal to 0, and a standing wave coefficient is equal to 1. A degree of matching between the antenna and the transmission line is measured by a reflection coefficient or a standing wave ratio at the input end of the antenna. For a transmit antenna, if matching is poor, radiated power of the antenna decreases, a loss on the transmission line increases, a power capacity of the transmission line also decreases, and in severe cases, even a “pulling” phenomenon on a transmitter frequency occurs. In other words, an oscillation frequency changes.

The capacitor in embodiments of this application may be understood as a lumped capacitor and/or a distributed capacitor. The lumped capacitor is a capacitive component, for example, a capacitive element. The distributed capacitor (or a distributed type capacitor) is an equivalent capacitor formed by two conductive members that are spaced by a specific slot. The inductor may be understood as a lumped inductor and/or a distributed inductor. The lumped inductor is an inductive component, for example, an inductive element. The distributed inductor (or a distributed type inductor) is an equivalent inductor formed by a conductive part of a specific length, for example, an equivalent inductor formed by a conductor due to bending or rotation.

In addition, the ground plate 202 (or ground) in embodiments of this application may generally refer to at least a part of any ground plane, grounding plate, ground metal plane, or the like in the electronic device 01 (for example, a smartwatch), or at least a part of any combination of the foregoing ground plane, the grounding plate, the ground component, or the like. The ground plate 202 (or the ground) may include any one or more of the following: a ground plane of the circuit board 14 (as shown in FIG. 1) of the electronic device 01, a ground metal plane formed by a metal film under the display 10, a conductive ground plane of the battery, and a conductive part or a metal part that is electrically connected to the ground plane/grounding plate/ground metal plane. Any one of the foregoing ground plane, the grounding plate, or the ground metal plane is made of a conductive material. In an embodiment, the conductive material may be any one of the following materials: copper, aluminum, stainless steel, brass and an alloy thereof, copper foil on an insulation substrate, aluminum foil on the insulation substrate, gold foil on the insulation substrate, silver-plated copper, silver-plated copper foil on the insulation substrate, silver foil and tin-plated copper on the insulation substrate, cloth impregnated with graphite powder, a graphite-coated substrate, a copper-plated substrate, a brass-plated substrate, and an aluminum-plated substrate. A person skilled in the art may understand that the ground plane/grounding plate/ground metal plane may alternatively be made of another conductive material.

In an embodiment, the circuit board 14 shown in FIG. 1 may be a PCB. For example, the circuit board 14 may have 8, 10, 12, 13, or 14 layers of plates that include 8, 10, 12, 13, or 14 layers of conductive materials, or elements separated and electrically insulated by a dielectric layer or an insulation layer such as glass fiber, polymer, or the like. In an embodiment, the circuit board includes a medium substrate, a ground layer, and a wiring layer. The wiring layer and the ground layer are electrically connected through a via. For example, the ground plate 202 may be formed by performing a photoengraving (MASK) process on a metal layer on a surface of any layer of medium plate in the circuit board 14. Alternatively, in some other embodiments of this application, a metal layer may be disposed on a side that is of the circuit board 14 shown in FIG. 1 and that is close to the display 10, and the metal layer is used as the ground plate 202 shown in FIG. 2A. In addition, in some embodiments, an edge of the circuit board 14 may be considered as an edge of the ground plate 202 of the circuit board 14.

On this basis, due to internal compactness of the electronic device 01, a ground plate/grounding plate/ground layer is usually disposed in internal space that is 0 mm to 2 mm away from the inner surface of the frame 11. In an embodiment, a medium is filled between the frame 11 and the ground plate 202. When the frame 11 and the ground plate 202 are circular, a circumference of a circle enclosed by an inner surface contour of the filling medium may be simply considered as a circumference of the ground plate 202. Alternatively, a circumference of a circle enclosed by a contour formed by superimposing all conductive parts inside the frame 11 may be considered as the circumference of the ground plate 202. Alternatively, when the frame 11 and the ground plate 202 are rectangular, a length and a width of a rectangle enclosed by the inner surface contour of the filling medium may be simply considered as a length and a width of the ground plate 202. Alternatively, a length and a width of a rectangle enclosed by a contour formed by superposing all conductive parts inside the frame 11 may be considered as a length and a width of the ground plate 202.

Based on this, when the ring-shaped radiator 201 shown in FIG. 2A is used as at least a part of the frame 11 shown in FIG. 1, to ensure that the ring-shaped radiator 201 has a good radiation environment, in some embodiments, a spacing between the frame 11 and the ground plate 202 in a horizontal direction may be controlled, to meet an antenna clearance requirement. The spacing may range from 0.5 mm to 0.9 mm. In some other embodiments, an aperture may be disposed near the part that is of the frame 11 and that is used as the ring-shaped radiator 201. In an embodiment, the aperture may include an internal aperture provided in the electronic device 01, for example, an aperture invisible from an appearance surface of the electronic device 01. In an embodiment, the internal aperture may be formed by any one of or jointly formed by a plurality of the frame, the battery, the circuit board, the rear cover, the display, and other internal conductive parts. For example, the internal aperture may be formed by a mechanical part of the frame. In an embodiment, the aperture may further include a slot/slit/hole provided in the frame 11. In an embodiment, the slot/slit/hole in the frame 11 may be a cut formed in the frame, and the frame 11 is divided into two parts that are not directly electrically connected at the cut. In an embodiment, the aperture may further include a slot/slit/hole provided in the rear cover 12 or the display 10. In an embodiment, the rear cover 12 includes a conductive material, and an aperture disposed in the conductive material may be connected to the slit or the cut of the frame, to form a continuous aperture in the appearance surface of the electronic device 01.

It can be learned from the foregoing that, as shown in FIG. 2A, the antenna structure 20 may include the ring-shaped radiator 201, the ground plate 202, the feeding end F, and the first ground end G1. The following describes disposing positions of the feeding end F and the first ground end G1 by using an example. In some embodiments of this application, as shown in FIG. 2B, the ring-shaped radiator 201 has a preset geometric center O and an intersection point of a first center line O1-O1 and a second center line O2-O2 that are orthogonal to each other. The geometric center O of the ring-shaped radiator is disposed on the first center line O1-O1 and the second center line O2-O2.

The preset geometric center O of the ring-shaped radiator 201 may mean that a projection of the ring-shaped radiator 201 on a plane on which the ground plate 202 is located is a regular pattern or approximately a regular pattern. A central position of the regular pattern may be referred to as the preset geometric center O. For example, when the ring-shaped radiator 201 is a circular ring, the preset geometric center O of the ring-shaped radiator 201 may be a center of the circular ring. Alternatively, the preset geometric center O of the ring-shaped radiator 201 may be a center of gravity of the ring-shaped radiator 201.

On this basis, the feeding end F is disposed on the first center line O1-O1. Provided that a structure of the feeding end F intersects the first center line O1-O1, it may be understood that the feeding end F is disposed on the first center line O1-O1. Still as shown in FIG. 2B, the ring-shaped radiator 201 may include a first semi-ring 2011 and a second semi-ring 2012, and the first semi-ring 2011 and the second semi-ring 2012 are axisymmetrically disposed with respect to the second center line O2-O2. Based on this, the feeding end F and the first ground end G1 may be disposed on the ring-shaped radiator 201 (for example, the first semi-ring 2011 or the second semi-ring 2012). The first ground end G1 may be physically grounded, or may be grounded through a component.

The antenna structure 20 shown in FIG. 2B is a simple model of the antenna structure 20. In the simple model, impact of another mechanical part and/or component inside the electronic device 01 is not considered (that is, impact of a spurious mode is not considered). Therefore, the ground plate 202 is simplified into a complete and uniform circular solid ground plate, and the ground plate 202 may be disposed concentrically with the ring-shaped radiator 201. In addition, the ground plate 202 and the ring-shaped radiator 201 are disposed on a same plane. Based on this, after the ground plate 202 in the simple model shown in FIG. 2B is omitted, the ring-shaped antenna radiator 201, the first ground end G1, and the feeding end F may be simplified into a structure shown in FIG. 2C.

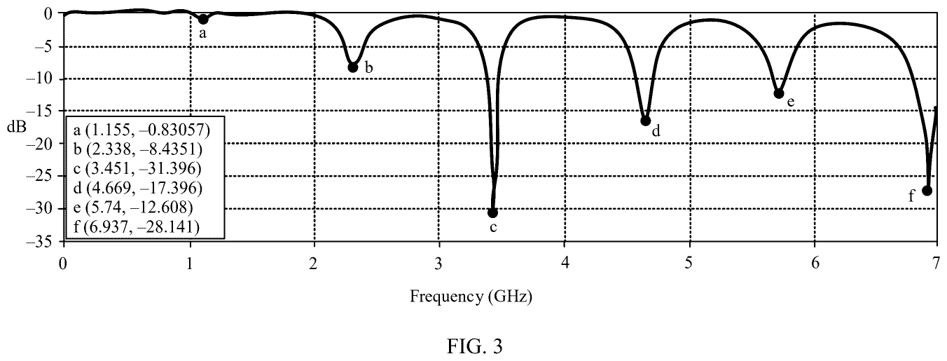

When the feeding end F and the first ground end G1 on the ring-shaped radiator 201 are disposed as shown in FIG. 2C, in the simple model, under excitation of the feeding end F, it can be learned from an S11 (antenna return loss) curve diagram shown in FIG. 3 that the ring-shaped radiator 201 may have a plurality of resonance frequency points, including: a point a (1.155, −0.83057), a point b (2.338, −8.4351), a point c (3.451, −31.396), a point d (4.669, −17.396), a point e (5.74, −12.608), and a point f (6.937, −28.141).

When the ring-shaped radiator 201 operates at a ½ wavelength (that is, 1λ/2) mode, the ring-shaped radiator 201 may generate a resonance in a 1.155 GHz frequency band (that is, the resonance frequency point a in FIG. 3). When the ring-shaped radiator 201 operates at a 1-fold wavelength (that is, 2λ/2) mode, the ring-shaped radiator 201 may generate a resonance in a 2.338 GHz frequency band (that is, the resonance frequency point b in FIG. 3). When the ring-shaped radiator 201 operates at a 3/2 wavelength (that is, 3λ/2) mode, the ring-shaped radiator 201 may generate a resonance in a 3.451 GHz frequency band (that is, the resonance frequency point c in FIG. 3).

In addition, when the ring-shaped radiator 201 operates in a 2-fold wavelength (that is, 2λ) mode, the ring-shaped radiator 201 may generate a resonance in a 4.669 GHz frequency band (that is, the resonance frequency point d in FIG. 3). When the ring-shaped radiator 201 operates in a 5/2 wavelength (that is, 5λ/2) mode, the ring-shaped radiator 201 may generate a resonance in a 5.74 GHz frequency band (that is, the resonance frequency point e in FIG. 3). When the ring-shaped radiator 201 operates in a 3-fold wavelength (that is, 3λ) mode, the ring-shaped radiator 201 may generate a resonance in a 6.937 GHz frequency band (that is, the resonance frequency point f in FIG. 3).

In this example, the antenna return loss may be understood as a ratio of power of a signal reflected back to an antenna port through an antenna circuit to transmit power of the antenna port. A smaller reflected signal indicates a larger signal radiated through an antenna to space and higher radiation efficiency of the antenna. A larger reflected signal indicates a smaller signal radiated through the antenna to space and lower radiation efficiency of the antenna. The antenna return loss may be represented by an S11 parameter, and the S11 parameter is usually a negative number. A smaller S11 parameter indicates a smaller return loss of the antenna and higher radiation efficiency of the antenna. A larger S11 parameter indicates a larger return loss of the antenna and lower radiation efficiency of the antenna.

In embodiments of this application, a wavelength in a wavelength mode (for example, a ½ wavelength mode) of an antenna may be a wavelength of a signal radiated by the antenna. For example, the ½ wavelength mode of the ring-shaped radiator 201 may generate the resonance in the 1.155 GHz frequency band, where a wavelength in the ½ wavelength mode is a wavelength of a signal of the ring-shaped radiator 201 in the 1.155 GHz frequency band. It should be understood that a wavelength of a radiation signal in the air may be calculated as follows: (Air wavelength or vacuum wavelength)-Speed of light/Frequency, where the frequency is a frequency (MHz) of the radiation signal, and the speed of light may be 3×108 m/s. A wavelength of the radiation signal in a medium may be calculated as follows: Medium wavelength=(speed of light/\sqrt{ϵ})/frequency, where ϵ is a relative dielectric constant of the medium. The wavelength in embodiments of this application is usually a medium wavelength, and may be a medium wavelength corresponding to a center frequency of a resonance frequency, or a medium wavelength corresponding to a center frequency of an operating frequency band supported by the antenna. Alternatively, not limited to the center frequency, the “medium wavelength” may also refer to a medium wavelength corresponding to a resonance frequency or a non-center frequency of an operating frequency band. For ease of understanding, the medium wavelength mentioned in embodiments of this application may be simply calculated by using a relative dielectric constant of a medium filled in one or more sides of a radiator.

In addition, when the ring-shaped radiator 201 operates in the ½ wavelength (that is, 1λ/2) mode, a current distribution diagram of the ring-shaped radiator 201 is shown in (a1) in FIG. 4, and a three-dimensional antenna pattern of the ring-shaped radiator 201 is shown in (a2) in FIG. 4. It can be learned that a direction of a current zero point (circled by a dashed line in the figure) shown in (a1) in FIG. 4 is consistent with a direction of a zero point in a directivity pattern shown in (a2) in FIG. 4. In addition, it can be learned that a direction of a current intensity point (a part with the deepest color) shown in (a1) in FIG. 4 is consistent with a direction of maximum radiation shown in (a2) in FIG. 4.

The antenna pattern is also referred to as a radiation pattern. The antenna pattern is a pattern in which relative field strength (a normalized modulus value) of a radiation field of the antenna changes with a direction at a specific distance from the antenna, and is usually represented by two planar antenna patterns that are perpendicular to each other in a maximum radiation direction of the antenna. The antenna pattern usually includes a plurality of radiation beams. A radiation beam with highest radiation intensity is referred to as a main lobe, and the other radiation beams are referred to as minor lobes or side lobes. In the minor lobes, a minor lobe in an opposite direction of the main lobe is also referred to as a back lobe.

In addition, when the ring-shaped radiator 201 operates in the 1-fold wavelength (that is, 2λ/2) mode, a current distribution diagram of the ring-shaped radiator 201 is shown in (b1) in FIG. 4, and a three-dimensional antenna pattern of the ring-shaped radiator 201 is shown in (b2) in FIG. 4. When the ring-shaped radiator 201 operates in the 3/2 wavelength (that is, 3λ/2) mode, a current distribution diagram of the ring-shaped radiator 201 is shown in (c1) in FIG. 4, and a three-dimensional antenna pattern of the ring-shaped radiator 201 is shown in (c2) in FIG. 4. When the ring-shaped radiator 201 operates in the 2-fold wavelength (that is, 22) mode, a current distribution diagram of the ring-shaped radiator 201 is shown in (d1) in FIG. 4, and a three-dimensional antenna pattern of the ring-shaped radiator 201 is shown in (d2) in FIG. 4. When the ring-shaped radiator 201 operates in the 5/2 wavelength (that is, 5λ/2) mode, a current distribution diagram of the ring-shaped radiator 201 is shown in (e1) in FIG. 4, and a three-dimensional antenna pattern of the ring-shaped radiator 201 is shown in (e2) in FIG. 4. When the ring-shaped radiator 201 operates in the 3-fold wavelength (that is, 32) mode, a current distribution diagram of the ring-shaped radiator 201 is shown in (f1) in FIG. 4, and a three-dimensional antenna pattern of the ring-shaped radiator 201 is shown in (f2) in FIG. 4. Similarly, it can be learned from the foregoing accompanying drawings that a direction of a current zero point (circled by a dashed line in the figure) is consistent with a direction of a zero point in the directivity pattern, and a direction of a current intensity point (a part with the deepest color) is consistent with a direction of maximum radiation.

In addition, when the ring-shaped radiator 201 is in a low order mode, for example, in the 1λ/2 wavelength mode, as shown in (a2) in FIG. 4, radiation of the directivity pattern at each position is uniform, and the ring-shaped radiator 201 does not have a good directional radiation feature. When the ring-shaped radiator 201 is in a high order mode, for example, the 3λ/2 mode, the 22 mode, the 5λ/2 mode, and the 32 mode, it can be learned from (c1) in FIG. 4, (d1) in FIG. 4, (e1) in FIG. 4, and (f1) in FIG. 4 that there are a large quantity of current zero points (circled by dashed lines in the figure) (>3), and the ring-shaped radiator 201 does not have a good directional radiation feature.

However, when the ring-shaped radiator 201 is in the low order mode, for example, in the 1-fold wavelength (that is, 2λ/2) mode, the directivity pattern (b2) in FIG. 4 mainly points to a normal direction (a vertical direction in the figure), and the ring-shaped radiator 201 has a good directional radiation feature. Based on this, it can be learned that when the ring-shaped radiator 201 provided in embodiments of this application operates in the 1-fold wavelength (that is, 2λ/2) mode, the ring-shaped radiator 201 can obtain a good directional radiation feature.

The foregoing is described by using an example in which when the ring-shaped radiator 201 operates in the 1-fold wavelength (that is, 2λ/2) mode, the ring-shaped radiator 201 may generate the resonance in the 2.338 GHz frequency band (that is, the resonance frequency point b in FIG. 3). When the ring-shaped radiator 201 operates in the 1-fold wavelength (that is, 2λ/2) mode, the ring-shaped radiator 201 may further generate a resonance of another frequency band, for example, at least one of an L1 frequency band (1575.42 MHZ+1.023 MHz) or an L5 frequency band (1176.45 MHz+1.023 MHz) of a GPS.

It can be learned from the foregoing that, when the feeding end F and the first ground

end G1 on the ring-shaped radiator 201 are disposed as shown in FIG. 2C, and the ring-shaped radiator 201 operates in the 1-fold wavelength (that is, 2λ/2) mode, current distribution on the ring-shaped radiator is shown in (b1) in FIG. 4. The feeding end F and the first ground end G1 may be located in a large current area. A current distributed on the ring-shaped radiator has two current zero points (circled by dashed lines in the figure). Current flow directions of currents between the two adjacent current zero points are the same. An operating mode of the ring-shaped radiator may be referred to as an antisymmetry (antisymmetry) mode, or may be referred to as a differential mode (differential mode, DM mode for short). Therefore, the ring-shaped radiator 201 may be excited to operate mainly in the DM mode by being at the feeding end F and the first ground end G1. In some implementations, the operating mode of the ring-shaped radiator includes a 1-fold wavelength DM mode.

In embodiments of this application, the foregoing description is provided by using an example in which the operating mode of the ring-shaped radiator 201 is referred to as the “1-fold wavelength DM mode” when current distribution on the ring-shaped radiator is shown in FIG. 4 (b1). The “1-fold wavelength” cannot be used to limit the operating mode of the ring-shaped radiator 201. For example, when the ring-shaped radiator 201 operates in a 1.5λ DM mode, current distribution on the ring-shaped radiator 201 is also shown in (b1) in FIG. 4. This also falls within the protection scope of the “DM mode” in embodiments of this application. Therefore, when current distribution on the ring-shaped radiator is shown in (b1) in FIG. 4, the current distribution has the following features: The current distributed on the ring-shaped radiator has two current zero points (circled by dashed lines in the figure), and current flow directions between the two adjacent current zero points are the same. This belongs to the “DM mode” in this embodiment of this application. For ease of description, in the following embodiments, the “1-fold wavelength” DM mode is used as an example to describe an operating principle of embodiments in this specification, and is referred to as a “DM mode” for short below.

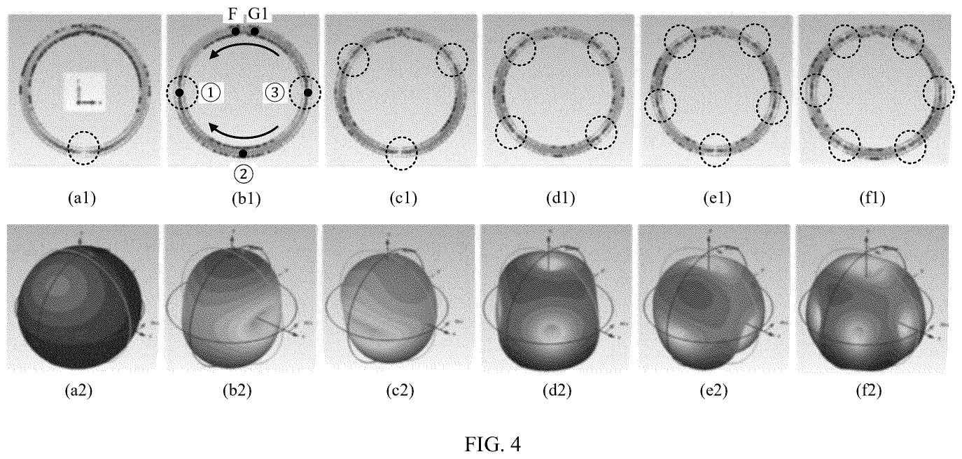

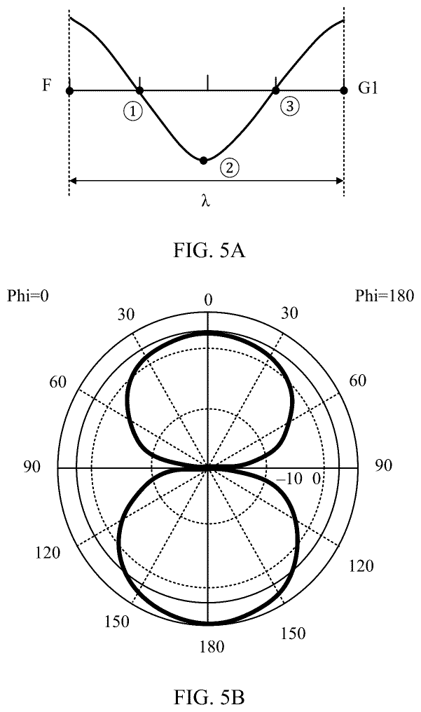

Based on this, a current distribution curve of the ring-shaped radiator is shown in FIG. 5A. It can also be learned that the feeding end F and the first ground end G1 are located at peak positions of the current distribution curve. There are two current zero points (a point 1 and a point 3) on the current distribution curve. A quantity of current zero points is consistent with a quantity of current zero points shown in (b1) in FIG. 4. Currents between the two adjacent current zero points (the point 1 and the point 3) are all located on a negative half axis of coordinates. There is no current reverse point between the two adjacent current zero points.

Based on this, when the ring-shaped radiator 201 operates mainly in the DM mode, a planar antenna pattern (obtained by sectioning in a longitudinal direction in (b2) in FIG. 4) of the ring-shaped radiator 201 is shown in FIG. 5B. It can be learned that the ring-shaped radiator 201 has a good directional radiation feature in a direction in which an included angle phi in an azimuth plane is 0° and 180°.

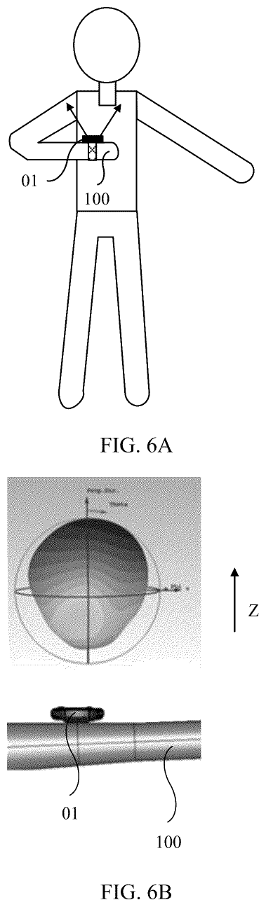

In this case, when a user lifts an arm to watch a worn smartwatch (the electronic device 01) as shown in FIG. 6A, a watch face of the smartwatch faces the sky. In this case, the ring-shaped radiator 201 in the electronic device 01 may operate mainly in the DM mode. A three-dimensional antenna pattern of the ring-shaped radiator 201 is shown in FIG. 6B. It can be learned that a main radiation direction of the ring-shaped radiator 201 is in a vertical direction Z, that is, is perpendicular to the watch face of the electronic device 01 worn on an arm 100 of the user, and is in a direction that faces the sky shown in FIG. 6A (indicated by arrows in the figure). Therefore, in embodiments of this application, the DM mode of the ring-shaped radiator 201 may be referred to as a zenith mode.

In this way, when the user lifts the arm to watch the worn smartwatch (the electronic device 01), a main radiation direction of the ring-shaped radiator 201 in the electronic device 01 points to the zenith, thereby further helping improve signal strength and signal transmission efficiency between the electronic device 01 and the satellite. This helps the electronic device 01 perform a satellite alignment operation and signal communication with the satellite, to improve satellite communication and positioning accuracy.

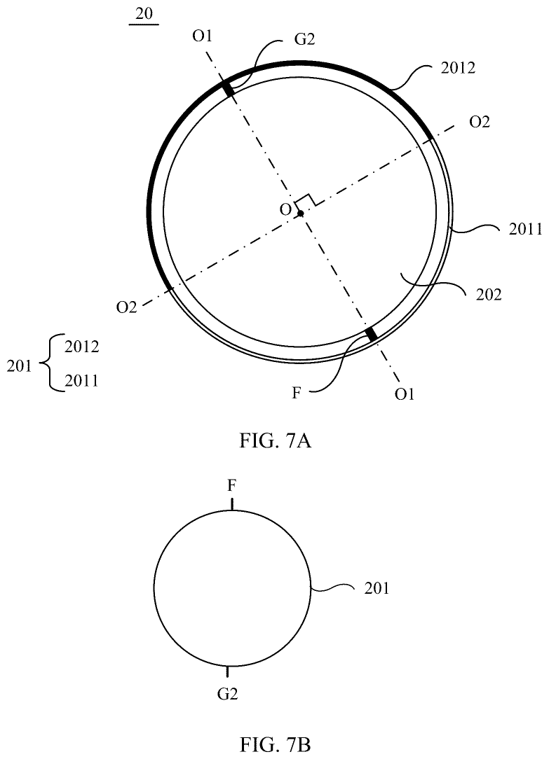

In some other embodiments of this application, as shown in FIG. 7A, the ground end of the antenna structure 20 may be the second ground end G2. The second ground end G2 may be disposed on a second semi-ring 2021, and the second ground end G2 is coupled to the ground plate 202. Based on this, after the ground plate 202 in a simple model shown in FIG. 7A is omitted, the ring-shaped antenna radiator 201, the second ground end G2, and the feeding end F may be simplified into a structure shown in FIG. 7B.

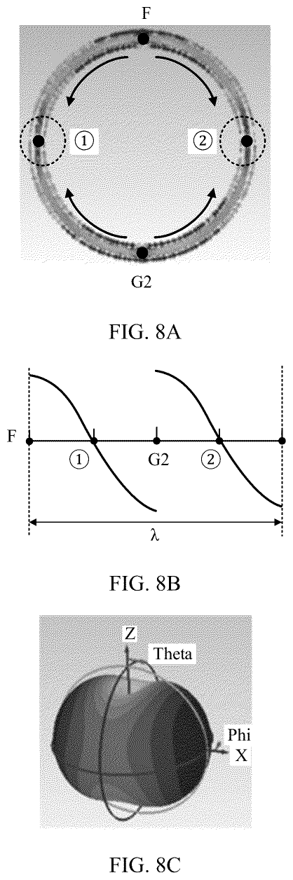

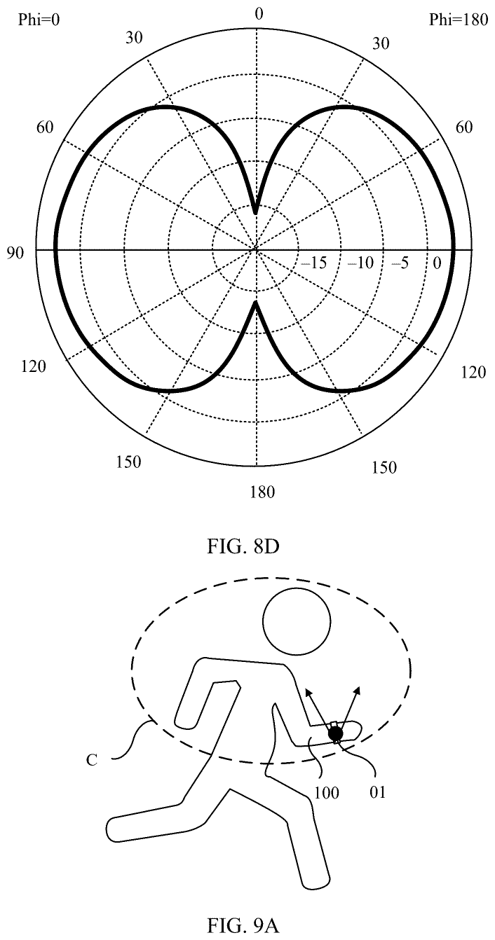

Based on this, when the feeding end F and the second ground end G2 on the ring-shaped radiator 201 are disposed as shown in FIG. 7B, and the ring-shaped radiator 201 operates in the 1-fold wavelength (that is, 2λ/2) mode, current distribution on the ring-shaped radiator is shown in FIG. 8A. Current flow directions between two adjacent current zero points (circled by dashed lines in the figure) of a current that is distributed on the ring-shaped radiator are opposite, for example, are opposite at positions of the second ground end G2 and the feeding end F. Based on this, a current distribution curve of the ring-shaped radiator 201 is shown in FIG. 8B. It can also be learned that there are two current zero points (a point 1 and a point 2) on the current distribution curve. A quantity of current zero points is consistent with a quantity of current zero points shown in FIG. 8A. In addition, current flow directions between the two adjacent current zero points (the point 1 and the point 2) are opposite. To be specific, one part is located on a positive half axis, and the other part is located on a negative half axis. Therefore, there is a current reverse point (that is, a position of the second feeding end G2) between the two adjacent current zero points. In this case, an operating mode of the ring-shaped radiator may be referred to as a symmetry (symmetry) mode, or may be referred to as a common mode (common mode, CM mode for short). In some implementations, the operating mode of the ring-shaped radiator includes a 1-fold wavelength CM mode.

In this embodiment of this application, the foregoing description is provided by using an example in which when current distribution on the ring-shaped radiator is shown in FIG. 8A, the operating mode of the ring-shaped radiator 201 is referred to as the “1-fold wavelength CM mode.” The “1-fold wavelength” cannot be used to limit the operating mode of the ring-shaped radiator 201. For example, when the ring-shaped radiator 201 operates in the 1.52 CM mode, current distribution on the ring-shaped radiator 201 is also shown in FIG. 8A. This also falls within the protection scope of the “CM mode” in this embodiment of this application. Therefore, current distribution on the ring-shaped radiator shown in FIG. 8A having a feature that current flow directions are opposite between two adjacent current zero points (circled by dashed lines in the figure) at which a current is distributed on the ring-shaped radiator belongs to the “CM mode” in this embodiment of this application. For ease of description, in the following embodiments, the “1-fold wavelength” CM mode is used as an example to describe an operating principle of embodiments of this specification, and is referred to as a “CM mode” for short below.

When the ring-shaped radiator 201 operates mainly in the CM mode, as shown in FIG. 8C, a three-dimensional antenna pattern of the ring-shaped radiator 201 can be learned that a main radiation direction of the ring-shaped radiator is a horizontal direction in the figure. In other words, the ring-shaped radiator has a good directional radiation feature in the horizontal direction. Based on this, a planar antenna pattern (obtained by sectioning in a transverse direction X axis in (b2) in FIG. 8C) of the ring-shaped radiator 201 is shown in FIG. 8D. It can be learned that the ring-shaped radiator 201 has a good directional radiation feature in a direction in which an included angle phi in an azimuth plane is 90°.

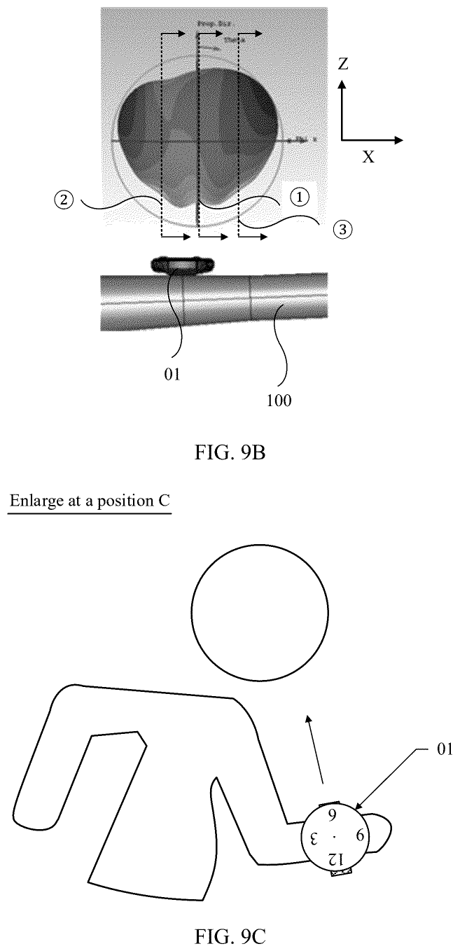

Based on this, as shown in FIG. 9A, the arm of the user is laterally placed. For example, when the user wears the smartwatch and runs, in a process in which the arm 100 swings, the arm 100 is lifted and placed laterally. In this case, the surface of the watch face of the smartwatch (the electronic device 01) worn by the user is vertically placed. In this case, the ring-shaped radiator 201 in the electronic device 01 may operate in the CM mode. A three-dimensional antenna pattern of the ring-shaped radiator 201 is shown in FIG. 9B. It can be learned that a beam direction of an electromagnetic wave radiated by the ring-shaped radiator 201 is in a horizontal X direction, that is, is parallel to a watch face of the electronic device 01 worn on the arm 100 of the user. Therefore, as shown in FIG. 9A (indicated by an arrow in the figure), a beam direction of an electromagnetic wave radiated by the ring-shaped radiator 201 may face a direction of the sky. Based on this, in this embodiment of this application, the CM mode of the ring-shaped radiator 201 may be referred to as a horizontal mode.

In this way, it can be learned from FIG. 9C (an enlarged view at a position C in FIG. 9A) that when the arm 100 of the user is placed laterally, for example, when the user runs, a 6 o'clock (or 12 o'clock) direction of a watch face pattern of the electronic device 01 (for example, the smartwatch) faces upward. When the arm 100 of the user is placed laterally as shown in FIG. 9C, the ring-shaped radiator 201 operates in the CM mode, the electromagnetic wave radiated by the ring-shaped radiator is in a plane parallel to a surface of a watch cover. At a 6 o'clock position and a position near the 6 o'clock position (for example, an 8 o'clock position or a 4 o'clock position), a directivity coefficient is increased. Therefore, a beam direction of the electromagnetic wave radiated by the ring-shaped radiator 201 operating in the CM mode can face the sky (in a direction of an arrow in FIG. 9C) at the 6 o'clock position and the position near the 6 o'clock position.

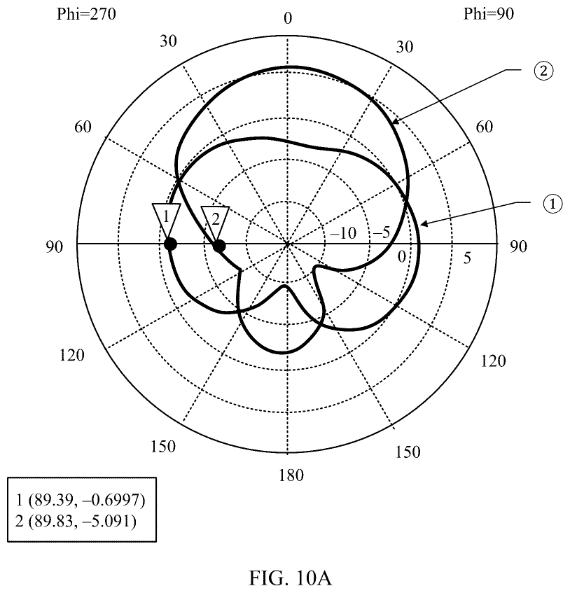

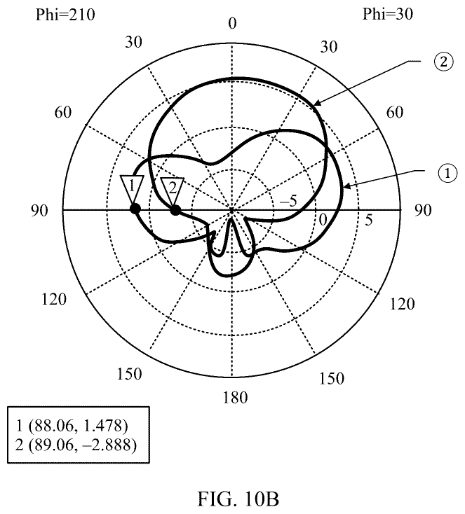

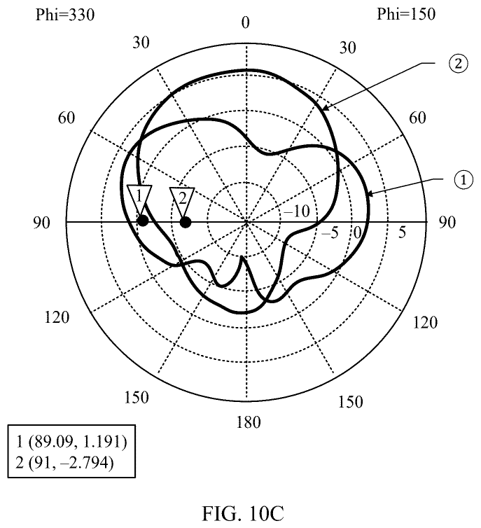

For example, FIG. 10A is a planar antenna pattern obtained by sectioning along a position 1 (corresponding to the 6 o'clock position in FIG. 9C) in FIG. 9B. An included angle phi in an azimuth plane in FIG. 10A is between 90° and 270°. A curve 1 is a planar antenna pattern when the ring-shaped radiator 201 operates in the CM mode. A point 1 (89.39, −0.6997) whose pitch plane angle theta is close to 90° is selected from the curve in the directivity pattern. In other words, a pitch plane angle theta at the position of the point 1 is 89.39°, and a direction coefficient is −0.6997.

In addition, a curve 2 is a planar antenna pattern when the ring-shaped radiator 201 operates in the DM mode. A point 2 (89.83, −5.091) whose pitch plane angle theta is close to 90° is selected from the curve in the directivity pattern. In other words, a pitch plane angle theta at the position of the point 2 is 89.83°, and a direction coefficient is −5.091. Therefore, when the arm 100 of the user is lifted and laterally placed as shown in FIG. 9C, a directivity coefficient of the 6 o'clock position may be increased by ΔK1=|−0.6997−(−5.091)|≈4.4 dB.

Alternatively, for another example, FIG. 10B is a planar antenna pattern obtained by sectioning along a position 2 (corresponding to a position near an 8 o'clock position in FIG. 9C) in FIG. 9B. An included angle phi in an azimuth plane in FIG. 10B is between 30° and 210°. A curve 1 is a planar antenna pattern when the ring-shaped radiator 201 operates in the CM mode. A point 1 (88.06, 1.478) whose pitch plane angle theta is close to 90° is selected from the curve in the directivity pattern. In other words, a pitch plane angle theta at the position of the point 1 is 88.06°, and a direction coefficient is 1.478.

In addition, a curve 2 is a planar antenna pattern when the ring-shaped radiator 201 operates in the DM mode. A point 2 (89.06, −2.888) whose pitch plane angle theta is close to 90° is selected from the curve in the directivity pattern. In other words, a pitch plane angle theta at the position of the point 2 is 89.06°, and a direction coefficient is −2.888. Therefore, when the arm 100 of the user is laterally placed as shown in FIG. 9C, a directivity coefficient of the position near the 8 o'clock position may be increased by ΔK2=|1.478−(−2.888)|≈4.3 dB.

Alternatively, for another example, FIG. 10C shows a planar antenna pattern obtained by sectioning along a position 3 (corresponding to a position near a 4 o'clock position in FIG. 9C) in FIG. 9B. An included angle phi in an azimuth plane in FIG. 10C is between from 150° to 330°. A curve 1 is a planar antenna pattern when the ring-shaped radiator 201 operates in the CM mode. A point 1 (88.09, 1.191) whose pitch plane angle theta is close to 90° is selected from the curve in the directivity pattern. In other words, a pitch plane angle theta at the position of the point 1 is 88.09°, and a direction coefficient is 1.191.

In addition, a curve 2 is a planar antenna pattern when the ring-shaped radiator 201 operates in the DM mode. A point 2 (91, −2.794) whose pitch plane angle theta is close to 90° is selected from the curve in the directivity pattern. In other words, a pitch plane angle theta at the position of the point 2 is 91°, and a direction coefficient is −5.794. Therefore, when the arm 100 of the user is laterally placed as shown in FIG. 9C, a directivity coefficient of the position near the 4 o'clock position may be increased by ΔK3=|1.191−(−2.794)|≈3.9 dB.

It can be learned from the foregoing that, when the arm 100 of the user is switched from a horizontal placement position shown in FIG. 6A to a lateral placement position shown in FIG. 9C, the operating mode of the ring-shaped radiator 201 is switched from the DM mode to the CM mode. In addition, in the plane parallel to the surface of the watch cover, the directivity coefficient of the electromagnetic wave radiated by the ring-shaped radiator may increase by about 4 dB at the 6 o'clock position and a position near the 6 o'clock position (for example, the 8 o'clock position or the 4 o'clock position). Therefore, when the arm of the user is placed laterally, for example, in a running process, a main radiation direction of the ring-shaped radiator 201 in the electronic device 01 is parallel to the watch face. Because the surface of the watch face is approximately perpendicular to the sky, the main beam direction of the electromagnetic wave of the ring-shaped radiator 201 may face the 6 o'clock position and the position near the 6 o'clock position (for example, the 8 o'clock position or the 4 o'clock position), and may still face the sky. In this way, as described above, satellite communication and positioning accuracy can be improved.

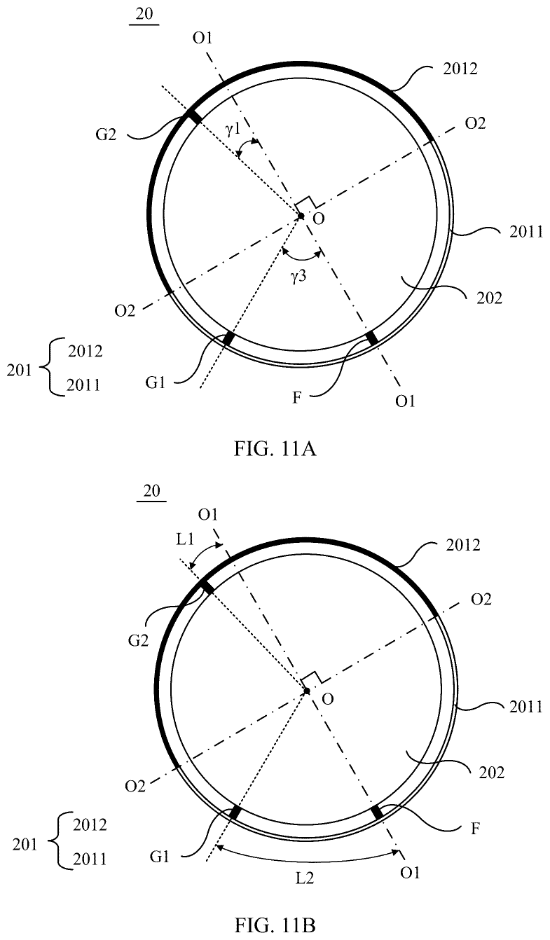

It can be learned from the foregoing that the first ground end G1 and the feeding end F shown in FIG. 2B may excite the ring-shaped radiator 201 to operate mainly in the DM mode. In an embodiment, in current distribution in the DM mode, the main radiation direction of the ring-shaped radiator 201 is perpendicular to the watch face of the electronic device 01 worn on the arm 100 of the user. In an embodiment, in current distribution in the DM mode, in the direction perpendicular to the watch face of the electronic device 01, a radiation gain of the ring-shaped radiator 201 is high. The second ground end G2 and the feeding end F shown in FIG. 7A may excite the ring-shaped radiator 201 to operate mainly in the CM mode. In an embodiment, in current distribution in the CM mode, a main radiation direction of the ring-shaped radiator 201 is parallel to a plane on which the watch face of the electronic device 01 worn on the arm 100 of the user is located. In an embodiment, in current distribution in the CM mode, in a direction parallel to the watch face of the electronic device 01, a radiation gain of the ring-shaped radiator 201 is high. Based on this, to enable the ring-shaped radiator 201 to operate in both the DM mode and the CM mode, as shown in FIG. 11A, the antenna structure 20 may include the first feeding end G1 and the second feeding end G2.

It should be understood that, in current distribution in the DM mode, in the direction perpendicular to the watch face of the electronic device 01, that the radiation gain of the ring-shaped radiator 201 is high may be relative to the current distribution in the CM mode. In current distribution in the CM mode, in the direction parallel to the watch face of the electronic device 01, that the radiation gain of the ring-shaped radiator 201 is high may be relative to the current distribution in the DM mode.

Based on this, to make it easier for the second ground end G2 and the feeding end F to excite the ring-shaped radiator 201 to operate mainly in the CM mode, as shown in FIG. 11A, there is a first included angle γ1 between the first center line O1-O1 and a connection line between the second ground end G2 and the geometric center O, and γ1 ranges from −60° to +60°. In this case, an example in which the ring-shaped radiator 201 is a circular ring is used. The first ground end G1 may be disposed on a part (that is, a part in a range of the remaining 240°) other than a part in a range of the first included angle γ1 on the ring-shaped radiator 201. In other words, the first ground end G1 and the feeding end F can excite the ring-shaped radiator 201 to operate mainly in the DM mode.

For example, γ1 ranges from −30° to +30°, or γ1 ranges from −15° to +15°, or γ1 ranges from −10° to +10°, or γ1 ranges from −5° to +5°. In this way, the second ground end G2 and the feeding end F can more easily excite the ring-shaped radiator 201 to operate mainly in the CM mode, the electromagnetic wave radiated by the ring-shaped radiator 201 in the CM mode has better directivity in the 6 o'clock direction, and a signal is stronger.

Alternatively, in some other embodiments of this application, to make it easier for the second ground end G2 and the feeding end F to excite the ring-shaped radiator 201 to operate mainly in the CM mode and radiate a stronger signal, as shown in FIG. 11B, on the ring-shaped radiator 201, a minimum physical length from the second ground end G2 to the first center line O1-O1 is L1, and L1 ranges from 0 to 8.5π millimeters. For example, as shown in FIG. 11A, the second ground end G2 may be disposed on the first center line O1-O1. In this case, L1 shown in FIG. 11B may be 0. Provided that a structure of the second ground end G2 intersects the first center line O1-O1, it may be understood that the second ground end G2 is disposed on the first center line O1-O1. In this way, both the second ground end G2 and the feeding end F are disposed on the first center line O1-O1, so that the second ground end G2 and the feeding end F may be centrosymmetric with respect to the geometric center O.

In this embodiment of this application, on the ring-shaped radiator 201, the “minimum physical length” from the ground end (or the feeding end) to the center line (for example, the first center line O1-O1) refers to two a physical length between the ground end (or the feeding end) and a position of an intersection point closest to the ground end (or the feeding end) of two intersection points formed by an intersection of the ring-shaped radiator 201 and the foregoing center line on the ring-shaped radiator 201.

In this embodiment of this application, a length of the ring-shaped radiator 201 may be measured based on an outer ring of the ring-shaped radiator 201. For example, a circumference of the ring-shaped radiator 201 may be a circumference measured along the outer ring (or an outer diameter) of the ring-shaped radiator 201. The ground end (or the feeding end) may be an outer diameter that passes through the ground end (or the feeding end), and corresponds to an outer ring position of the ring-shaped radiator 201.

In addition, it can be learned from the foregoing that the first ground end G1 in FIG. 11A may be disposed on a part (that is, a part in a range of the remaining) 240° other than a part in a range) (120° of the first included angle γ1 on the ring-shaped radiator 201. In other words, the first ground end G1 and the feeding end F can excite the ring-shaped radiator 201 to operate mainly in the DM mode. On this basis, to make it easier for the first ground end G1 and the feeding end F to excite the ring-shaped radiator 201 to operate mainly in the DM mode, as shown in FIG. 11A, there is a third included angle γ3 between the first center line O1-O1 and a connection line between the first ground end G1 and the geometric center O, and γ3 ranges from −90° to +90° In some embodiments of this application, γ3 is not 0°, so that a position of the first ground end G1 may not overlap a position of the feeding end F.

Alternatively, in some other embodiments of this application, to make it easier for the first ground end G1 and the feeding end F to excite the ring-shaped radiator 201 to operate mainly in the DM mode, as shown in FIG. 11B, on the ring-shaped radiator 201, a minimum physical length from the first ground end G1 to the feeding end is L2, and L2 ranges from 6π mm to 12.5π mm.

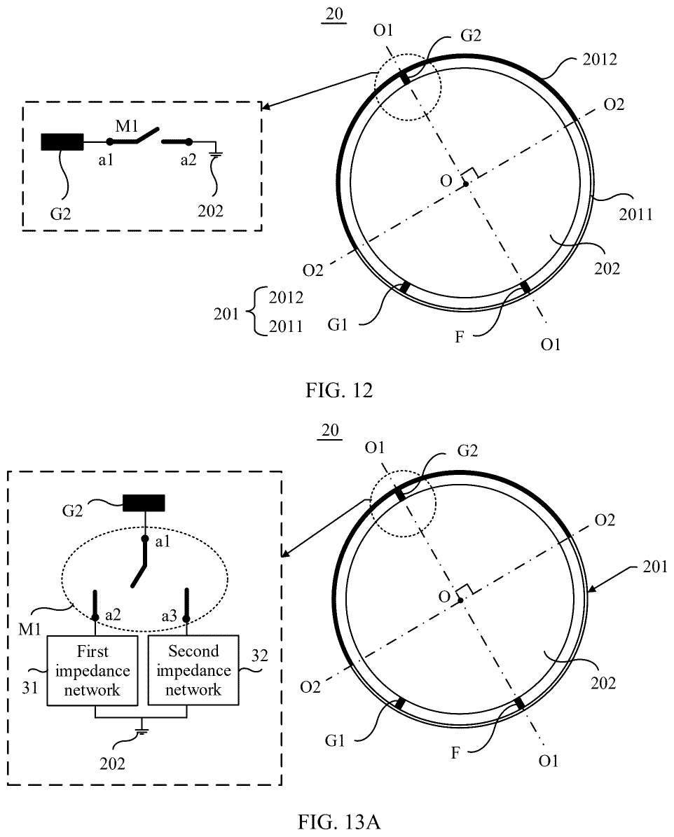

In this embodiment of this application, the “minimum physical length” from the ground end to the feeding end on the ring-shaped radiator 201 is a physical length of a part that is on the ring-shaped radiator 201 and that is closest to the ground end and the feeding end. In addition, when the feeding end and the ground end are prepared by using a mechanical part such as a spring plate, the “minimum physical length” may be a shortest distance between the two mechanical parts. It can be learned from the foregoing that, when both the first feeding end G1 and the second feeding end G2 in the antenna structure 20 are coupled to the ground plate 202, the ring-shaped radiator 201 may operate in both the DM mode and the CM mode. On this basis, to enable a main operating mode of the ring-shaped radiator 201 to be switched between the DM mode and the CM mode, in some embodiments of this application, as shown in FIG. 12, the antenna structure 20 may further include a first switch M1. The first switch M1 may be disposed between the second ground end G2 and the ground plate 202. A first end a1 of the first switch M1 is coupled to the second ground end G2, and a second end a2 of the first switch M1 may be coupled to the ground plate 202.

For example, the second end a2 of the first switch M1 may be directly coupled to the ground plate 202. When the first switch M1 is in a first state, the second ground end G2 may be electrically connected to the ground plate 202 (or in a grounded or short-circuited state) at the target frequency (for example, an L1 frequency band of a GPS), so that the ring-shaped radiator 201 may operate mainly in the CM mode. For example, when the first switch M1 is in the first state, the ring-shaped radiator 201 may implement physical grounding through the first switch M1. Alternatively, for another example, an impedance network may be disposed between the second end a2 of the first switch M1 and the ground plate 202. At the target frequency, when the first switch M1 is in the first state, the ring-shaped radiator 201 may implement grounding through a component by using the impedance network. Based on this, when the first switch M1 is in the second state, at the target frequency, the second ground end G2 is electrically isolated from the ground plate 202 (or is in a non-grounded or an open circuit state).

The target frequency in this embodiment of this application is a frequency band in which the operating mode of the antenna structure 20 changes in an operating mode switching process. In this embodiment of this application, a frequency of the antenna structure 20 may include an L1 frequency band of the GPS, an L5 frequency band of the GPS, and a Bluetooth (Bluetooth, BT) frequency band. The target frequency is not limited in this application. For ease of description, an example in which the L1 frequency band of the GPS is the target frequency is used for description in the embodiments. In addition, an operating mode switching process of the antenna structure 20 is described in detail by using an example in a subsequent embodiment.

In addition, in this embodiment of this application, that two components (for example, the second ground end G2 and the ground plate 202) are electrically connected means that the two components are electrically connected to each other, so that an electrical signal of a target frequency can be transmitted between the two components. In addition, that the two components are electrically isolated means that the two components are not electrically connected to each other, and an electrical signal of the target frequency cannot be transmitted between the two components.

In some embodiments of this application, to enable the second ground end G2 and the ground plate 202 to be electrically connected or electrically isolated, the second end a2 of the first switch M1 may be coupled to two components, for example, a first component and a second component. The first component and the second component may be used as impedance networks having a filtering function. When the first switch M1 is in the first state (that is, in a state of being close to a short circuit state, a conducted state, or a connected state), at the target frequency, the first component enables the foregoing two components, for example, the second ground end G2, to be electrically connected (or in a grounded or a short-circuited state with) to the ground plate 202. In this case, for the impedance network having the filtering function, the target frequency is a passband.

In addition, when the first switch M1 is in the second state (that is, in a state of being close to an open circuit state, a cut-off state, or a disconnected state), at the target frequency, the second component may enable the second ground end G2 to be electrically isolated from the ground plate 202 (or in a non-grounded or the open circuit state). For the impedance network having the filtering function, the target frequency is a stopband.

The foregoing is described by using an example in which the first state of the first switch M1 is a state of being close to the short circuit state, the conducted state, or the connected state, and the second state of the first switch M1 is a state of being close to the open circuit state, the cut-off state, or the disconnected state. In some embodiments of this application, the first state and the second state of the foregoing first switch M1 may alternatively be intermediate states of the short circuit state and an open circuit state. Alternatively, both the short circuit state and the open circuit state may be included in the first state and the second state. In this embodiment of this application, a first state and a second state of remaining switches, and an electrical connection state and an electrical isolation state between the two components are the same as those described above. Details are not described again.

In addition, when the foregoing impedance network having the filtering function includes a capacitor, when a capacitance value remains unchanged, a lower target frequency indicates that the impedance network is closer to the open circuit state. On the contrary, a higher target frequency indicates that the impedance network is closer to the short circuit state. In addition, when the target frequency remains unchanged, a larger capacitance value indicates that the impedance network is closer to the short circuit state. On the contrary, a smaller capacitance value indicates that the impedance network is closer to the open circuit state. Alternatively, for another example, when the foregoing impedance network includes an inductor, when an inductance value remains unchanged, a lower target frequency indicates that the impedance network is closer to the short circuit state. On the contrary, a higher target frequency indicates that the impedance network is closer to the open circuit state. In addition, when the target frequency remains unchanged, a larger inductance value indicates that the impedance network is closer to the open circuit state. On the contrary, a smaller inductance value indicates that the impedance network is closer to the short circuit state.

Based on this, to enable, at the target frequency, the electrical states of the first component and the second component that are mainly configured to form the foregoing impedance network having the filtering function to be different, in some embodiments of this application, an equivalent capacitance value (or an equivalent inductance value) of the first component may be greater than an equivalent capacitance value (or an equivalent inductance value) of the second component. Alternatively, on the contrary, the equivalent capacitance value (or the equivalent inductance value) of the foregoing first component may be less than the equivalent capacitance value (or the equivalent inductance value) of the second component. In this way, the equivalent capacitance values (or the equivalent inductance values) of the first component and the second component may be set based on different transmission signal frequencies.

In this case, when a frequency of the ring-shaped radiator 201 in the antenna structure 20 is or is close to the target frequency, for example, the L1 frequency band of the GPS, to enable the ring-shaped radiator 201 to operate mainly in the DM mode or operate mainly in the DM mode, and to not greatly affect the L5 frequency band and a BT frequency band of the GPS, the antenna structure 20 may include at least one impedance network disposed between the foregoing ground end and the ground plate 202. The at least one impedance network may be the foregoing impedance network having the filtering function. It can be learned from the foregoing that the impedance network includes components such as a capacitor/inductor/resistor that are connected in series or in parallel, so that the ground end can be electrically connected to the ground plate 202 by using the impedance network, to implement grounding through a component of the feeding end. The foregoing impedance network may perform at least one of impedance matching and filtering.

For example, the foregoing at least one impedance network is disposed between the second ground end G2 and the ground plate 202. The antenna structure 20 may include a first impedance network 31 and a second impedance network 32 shown in FIG. 13A. The first impedance network 31 is disposed between the second end a2 of the first switch M1 and the ground plate 202, and the first impedance network 31 may be coupled to the second end a2 of the first switch M1 and the ground plate 202. The second impedance network 32 is disposed between the second ground end G2 and the ground plate 202.

In some embodiments of this application, the second impedance network 32 is disposed between a third end a3 of the first switch M1 and the ground plate 202, and the second impedance network 32 is coupled to the third end a3 of the first switch M3 and the ground plate 202. Based on this, for the target frequency (for example, the L1 frequency band of the GPS), the first switch M1 has two states: the second state and the first state.

In a target frequency state, when the first switch M1 is in the first state, the first end a1 and the second end a2 of the first switch M1 are electrically connected, so that at the target frequency, the second ground end G2 may be electrically connected to the ground plate 202 through the first switch M1 and the first impedance network 31. For example, in some embodiments, when the first switch M1 is in the first state, the first impedance network 31 may implement 0 ohm grounding of the second ground end G2. Alternatively, for another example, the first impedance network 31 may have an impedance matching function, so that an S parameter in the target frequency state can be tuned based on simulation and actual debugging. In this case, signals of all frequency bands included in the antenna structure 20 may be transmitted between the second ground end G2 and the ground plate 202.

In addition, in the target frequency state, when the first switch M1 is in the second state, the first end a1 and the second end a2 of the first switch M1 are electrically isolated. In this case, the first end a1 and the third end a3 of the first switch M1 are electrically connected. In this case, the second impedance network 32 may include a component that has an open circuit feature for the target frequency (for example, the L1 frequency band of the GPS), for example, a capacitor with a small capacitance value or an inductor with a large inductance value. Alternatively, for another example, in the target frequency state, when the first switch M1 is in the second state, the first end a1 and the third end a3 of the first switch M1 may be electrically isolated.

Alternatively, in some other embodiments of this application, the second impedance network 32 is disposed between the third end a3 of the first switch M1 and the ground plate 202, and the second impedance network 32 is coupled to the third end a3 of the first switch M3 and the ground plate 202. Based on this, when the frequency of the antenna structure 20 includes the L1 frequency band of the GPS, the L5 frequency band of the GPS, and the BT frequency band, the L1 frequency band of the GPS is the target frequency. Based on this, for the target frequency (for example, the L1 frequency band of the GPS), the first switch M1 shown in FIG. 13A has two states: the second state and the first state. In a target frequency state, when the first switch M1 is in the first state, the first end a1 and the second end a2 of the first switch M1 are electrically connected, so that the second ground end G2 may be electrically connected to the ground plate 202 through the first switch M1 and the first impedance network 31.

The first impedance network 31 may have a filtering network structure with a low-pass response, so that when the second ground end G2 is electrically connected to the ground plate 202 through the first switch M1 and the first impedance network 31, the target frequency and a signal close to the target frequency can pass through the first impedance network 31. Another frequency band, for example, a signal of the L5 frequency band of the GPS and a signal of the BT frequency band, cannot pass through the first impedance network 31. In addition, in some embodiments, the first impedance network 31 may have an impedance matching function, so that the S parameter in the target frequency state can be tuned based on simulation and actual debugging.

In addition, in the target frequency state, when the first switch M1 is in the second state, the first end a1 and the second end a2 of the first switch M1 are electrically isolated. In this case, the first end a1 and the third end a3 of the first switch M1 are electrically connected. In this case, the second impedance network 32 may include a component that has an open circuit feature for both the target frequency (for example, the L1 frequency band of the GPS) and the remaining frequency bands (for example, the L5 frequency band of the GPS and the BT frequency band). Alternatively, for another example, in the target frequency state, when the first switch M1 is in the second state, the first end a1 and the third end a3 of the first switch M1 may be electrically isolated.

The foregoing is described by using an example in which the frequency of the target frequency is less than the frequency of the remaining frequency band. When the target frequency is greater than the frequency of the remaining frequency band, the first impedance network 31 may have a filtering network structure with a high-pass response. In this case, a process of disposing the first impedance network 31 and the second impedance network 32 may be similar, and details are not described herein again.

Alternatively, in some other embodiments of this application, as shown in FIG. 13B, the second impedance network 32 is disposed between the second ground end G2 and the ground plate 202, and the second impedance network 32 is coupled to the second ground end and the ground plate 202. In addition, the antenna structure 20 may further include a third impedance network 33. The third impedance network 33 is disposed between the third end a3 of the first switch M1 and the ground plate 202, and the third impedance network 33 is coupled to the third end a3 of the first switch M3 and the ground plate 202.

In this case, the target frequency of the antenna structure 20 is the L1 frequency band of the GPS, and a non-target frequency is the L5 frequency band of the GPS and the BT frequency band. Based on this, for the target frequency (for example, the L1 frequency band of the GPS), the first switch M1 shown in FIG. 13B has two states: the second state and the first state. In a target frequency state, when the first switch M1 is in the first state, the first end a1 and the second end a2 of the first switch M1 are electrically connected, so that the second ground end G2 may be electrically connected to the ground plate 202 through the first switch M1 and the first impedance network 31.

Similarly, the first impedance network 31 may have a filtering network structure with a low-pass response. When the second ground end G2 is coupled to the ground plate 202 through the first switch M1 and the first impedance network 31, the target frequency and a signal close to the target frequency can pass through the first impedance network 31. In addition, in some embodiments, the first impedance network 31 may have an impedance matching function, so that the S parameter in the target frequency state can be tuned based on simulation and actual debugging.

In addition, in the target frequency state, when the first switch M1 is in the second state, the first end a1 and the second end a2 of the first switch M1 are electrically isolated. In this case, the first end a1 and the third end a3 of the first switch M1 are electrically connected. The third impedance network 33 may include a device that has the open circuit feature for the target frequency (for example, the L1 frequency band of the GPS). Alternatively, for another example, in the target frequency state, when the first switch M1 is in the second state, the first end a1 and the third end a3 of the first switch M1 may be electrically isolated.

On this basis, as shown in FIG. 13B, regardless of whether the first switch M1 is in the second state or the first state, the second impedance network 32 may always be electrically connected to the second ground end G2 and the ground plate 202. The second impedance network 32 may have a filtering network structure with a high-pass response, so that when the second ground end G2 is coupled to the ground plate 202 through the first switch M1 and the second impedance network 32, a frequency band other than the target frequency for example, a signal of the L5 frequency band of the GPS and a signal of the BT frequency band, can be enabled to pass through the second impedance network 32. In addition, in some embodiments, the second impedance network 32 may have an impedance matching function, so that the S parameter in the target frequency state can be tuned based on simulation and actual debugging.

It can be learned from the foregoing that, in this embodiment of this application, when a switch between the feeding end and the ground plate 202, for example, the second state and the first state of the first switch, is for the target frequency, for the structure shown in FIG. 13B, a signal other than the target frequency may be transmitted by using another impedance network, for example, the second impedance network 32, when the switch is in the second state. Therefore, in a process in which the ring-shaped radiator 201 switches between the L1 frequency band of the GPS in the CM mode and the L1 frequency band of the GPS in the DM mode, impact on signals of other frequency bands, for example, the BT frequency band and the L5 frequency band of the GPS, can be reduced.

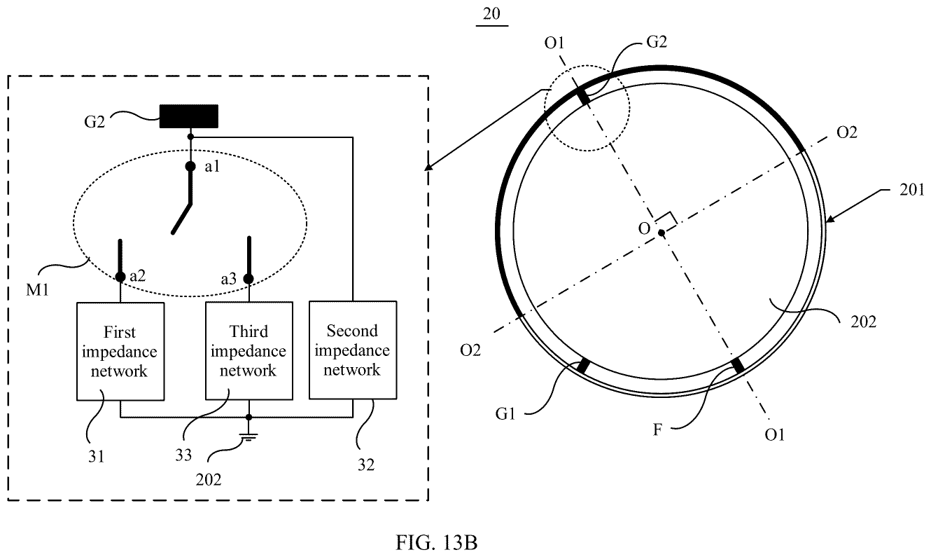

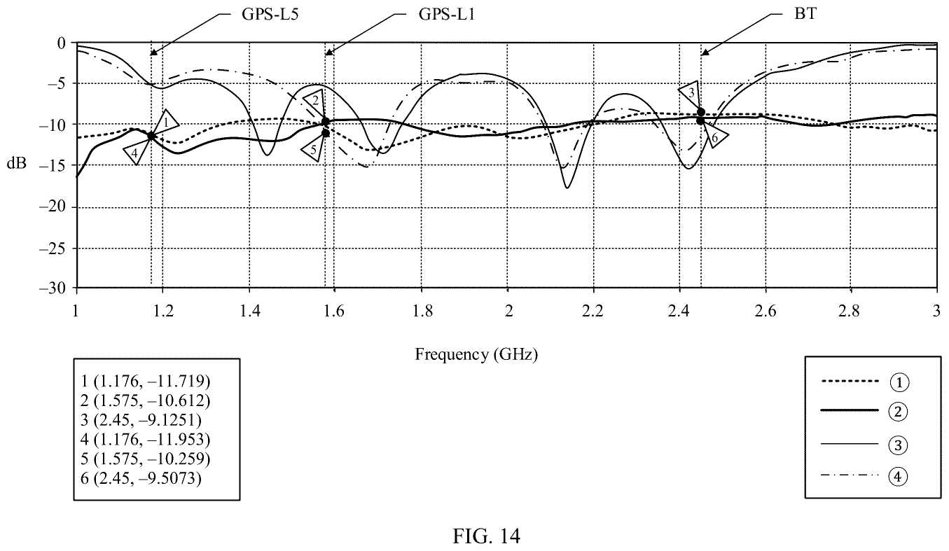

For example, as shown in FIG. 14, a curve 1 (a dashed line) is an antenna system efficiency curve when the ring-shaped radiator 201 operates mainly in the CM mode, and a curve 2 (a thick solid line) is an antenna system efficiency curve when the ring-shaped radiator 201 operates mainly in the DM mode. Antenna system efficiency is a ratio of power radiated by an antenna to space (that is, power of an electromagnetic wave part that is effectively converted) to input power of the antenna.

A point 1 (1.176, −11.719) on the curve 1 corresponds to the L5 frequency band of the GPS (GPS-L5 for short in the figure), and antenna system efficiency of the point 1 is −11.719 dB. A point 2 (1.575, −10.612) on the curve 1 corresponds to the L1 frequency band of the GPS (GPS-L1 for short), and antenna system efficiency of the point 2 is −10.612 dB. A point 3 (2.45, −9.1251) on the curve 1 corresponds to the BT frequency band, and antenna system efficiency of the point 3 is −9.1251 dB. It can be learned from the foregoing that the ring-shaped radiator 201 operates mainly in the CM mode. The antenna system efficiency of the L1 frequency band of the GPS, the L5 frequency band of the GPS, and the BT frequency band is between −10 dB and −12 dB. The antenna system efficiency can meet a design requirement.

In addition, a point 4 (1.176, −11.953) on the curve 2 corresponds to the L5 frequency band of the GPS (GPS-L5 for short in the figure), and antenna system efficiency of the point 4 is −11.953 dB. A point 5 (1.575, −10.259) on the curve 2 corresponds to the L1 frequency band of the GPS (GPS-L1 for short in the figure), and antenna system efficiency of the point 5 is −10.259 dB. A point 6 (2.45, −9.5073) on the curve 2 corresponds to the BT frequency band, and antenna system efficiency of the point 6 is −9.5073 dB. It can be learned from the foregoing that the ring-shaped radiator 201 operates mainly in the DM mode. The antenna system efficiency of the L1 frequency band of the GPS, the L5 frequency band of the GPS, and the BT frequency band is between −9 dB and −12 dB. The antenna system efficiency can meet a design requirement.

In conclusion, in a process of switching between the L1 frequency band in the CM mode and the L1 frequency band in the DM mode, the ring-shaped radiator 201 has small impact on antenna system efficiency of signals in other frequency bands, for example, the BT frequency band and the L5 frequency band. Therefore, the antenna system efficiency of each frequency band may be between −9 dB and −12 dB.

In addition, in FIG. 14, a curve 3 (a thin solid line) is an S11 curve in which the ring-shaped radiator 201 operates mainly in the DM mode, and a curve 4 (a dotted line) is an S11 curve in which the ring-shaped radiator 201 operates mainly in the CM mode. It can be learned that at a position of the L1 frequency band (GPS-L1 for short in the figure) of the GPS, antenna efficiency of the curve 3 (a thin solid line) and antenna efficiency of the curve 4 (a dotted line) are greatly different (Δ=about 5 dB). Therefore, it can be noted that the antenna structure 20 provided in the foregoing embodiment can implement switching between two the modes (the CM mode and the DM mode) on the L1 frequency band. In addition, because main beam directions of electromagnetic waves of the radiators of the antenna structure 20 in the two modes differ greatly, antenna efficiency differs greatly.

In some other embodiments of this application, the ring-shaped radiator 201 may further include a second switch M2 shown in FIG. 15. The second switch M2 is disposed between the first ground end G1 and the ground plate 202. A first end a1 of the second switch M2 is coupled to the first ground end G1. A second end a2 of the second switch M2 is coupled to the ground plate 202. For example, the second end a2 of the second switch M2 may be electrically connected to the ground plate 202. At the target frequency, when the second switch M2 is in a first state, the ring-shaped radiator 201 may be physically grounded by using the second switch M2. Alternatively, for another example, an impedance network may be disposed between the second end a2 of the second switch M2 and the ground plate 202. At the target frequency, when the second switch M2 is in the first state, the ring-shaped radiator 201 may implement grounding through a component by using the impedance network.

For example, the first switch M1, a first impedance network 31, and a second impedance network 32 that are disposed between the second ground end G2 and the ground plate 202 shown in FIG. 13A is used for description. For example, the first switch M1, the first impedance network 31, the second impedance network 32, and the third impedance network 33 that are disposed between the second ground end G2 and the ground plate 202 shown in FIG. 13B is used for description. As shown in FIG. 15, when the second switch M2 is disposed between the first feeding end G1 and the ground plate 202, a manner of disposing the impedance network shown in FIG. 13A and FIG. 13B may also be used between the first feeding end G1 and the ground plate 202. Details are not described herein again in this application.

Based on this, when the first switch M1 shown in FIG. 12 is in the second state, or the first switch M1 shown in FIG. 15 is in the second state, and the second switch M2 is in the first state, the second ground end G2 is electrically isolated from the ground plate 202 at the target frequency, and the first ground end G1 of the antenna structure 20 is electrically connected to the ground plate 202. When the ring-shaped radiator 201 is excited by the feeding end F and the first ground end G1, the ring-shaped radiator 201 operates mainly in the DM mode.

When the first switch M1 is in the first state and the second switch M2 is in the second state, the first ground end G1 is electrically isolated from the ground plate 202 at the target frequency, for example, in the L1 frequency band of the GPS. The second ground end G2 of the antenna structure 20 is electrically connected to the ground plate 202. When the ring-shaped radiator 201 is excited by the feeding end F and the second ground end G2, the ring-shaped radiator 201 operates mainly in the CM mode. At the target frequency, when both the first switch M1 and the second switch M2 are in the first state, the first ground end G1 and the second ground end G2 of the antenna structure 20 are electrically connected to the ground plate 202. When the ring-shaped radiator 201 is excited by the feeding end F, the first ground end G1, and the second ground end G2, the ring-shaped radiator 201 operates in the CM mode and the DM mode.

In conclusion, as shown in FIG. 12, the antenna structure 20 provided in this embodiment of this application includes the ring-shaped radiator 201. The ring-shaped radiator 201 includes a first semi-ring 2011 and a second semi-ring 2012 that are axially symmetrically disposed with respect to a second center line O2-O2. The feeding end F is disposed on the first semi-ring 2011, the second ground end G2 is disposed on the second semi-ring 2012, and the first ground end G1 is disposed on the ring-shaped radiator 201. The first switch M1 may be disposed between the second ground end G2 and the ground plate 202.

In some embodiments of this application, at the target frequency, when the first switch M1 is in the second state, and the first ground end G1 of the antenna structure 20 is electrically connected to the ground plate 202, the feeding end F and the first ground end G1 may excite the ring-shaped radiator 201 to operate mainly in the DM mode. In this case, a beam direction of an electromagnetic wave radiated by the ring-shaped radiator 201 is perpendicular to a surface of a watch face of the electronic device 01, for example, a smartwatch. In this case, when the user wears the electronic device 01, for example, the smartwatch, as shown in FIG. 6A, the arm 100 of the user is horizontally placed in the figure, so that the watch face of the watch is horizontal and faces the sky. As shown in FIG. 6B, because a main radiation direction of the ring-shaped radiator 201 is in a vertical direction Z, the beam direction of the electromagnetic wave radiated by the ring-shaped radiator 201 is perpendicular to the surface of the watch face. As shown in FIG. 6A, the beam direction (represented by an arrow in the figure) of the electromagnetic wave faces the sky (upward).

Alternatively, in some other embodiments of this application, at the target frequency, when the first switch M1 is in the first state, and the first ground end G1 and the second ground end G2 of the antenna structure 20 are electrically connected to the ground plate 202, the feeding end F, the first ground end G1, and the second ground end G2 may excite the ring-shaped radiator 201 to operate mainly in the CM mode. In this case, a beam direction of an electromagnetic wave radiated by the ring-shaped radiator 201 is parallel to a surface of a watch face of the electronic device 01, for example, a smartwatch. In this case, when the user wears the electronic device 01, for example, the smartwatch, as shown in FIG. 9A, the arm 100 of the user is vertically placed in the figure, so that the watch face of the watch is vertically placed. As shown in FIG. 9B, because the main radiation direction of the ring-shaped radiator 201 is parallel to an X direction of the watch face, and the beam direction of the electromagnetic wave radiated by the ring-shaped radiator 201 is parallel to the surface of the watch face, the main beam direction of the electromagnetic wave of the ring-shaped radiator 201 may face a 6 o'clock position and a position near the 6 o'clock position (for example, an 8 o'clock position or a 4 o'clock position), and may still face the sky.

In this way, when the user wears the electronic device 01, regardless of how the arm 100 of the user swings, that is, when the arm 100 is horizontally placed or placed laterally during running, the beam direction of the electromagnetic wave radiated by the ring-shaped radiator 201 in the electronic device 01 can point to the sky. Therefore, signal strength and signal transmission efficiency between the electronic device 01 and a satellite can be improved, so that the electronic device 01 and the satellite can perform a satellite alignment operation and signal communication, thereby improving satellite communication and positioning accuracy.

It can be learned from the foregoing that, in addition, when the first switch M1 is in the first state or the second state, a current distributed on the ring-shaped radiator 201 enables the antenna structure 20 to operate at the target frequency. At the target frequency, the ring-shaped radiator 201 may operate mainly in different antenna modes, for example, at least one of the DM mode and the CM mode. In the DM mode, the beam direction of the electromagnetic wave radiated by the ring-shaped radiator 201 may be perpendicular to the ground plate 202. In the CM mode, the beam direction of the electromagnetic wave radiated by the ring-shaped radiator 201 may be parallel to the ground plate 202. When the ring-shaped radiator 201 operates mainly in the DM mode, a current excited on the ring-shaped radiator 201 is a codirectional current between two current zero points. In the DM mode, a small ground plate current may be excited in the ground plate 202. Therefore, the ground plate current has small impact on the DM mode. Therefore, a size and a shape of the ground plate 202 have a little impact on the DM mode. When the ring-shaped radiator 201 operates mainly in the CM mode, a current excited on the ring-shaped radiator 201 is a reverse current between two current zero points. In the CM mode, a large ground plate current may be excited in the ground plate 202. Therefore, the ground plate current has a large impact on the CM mode. Therefore, a size and a shape of the ground plate 202 have a great impact on the DM mode.

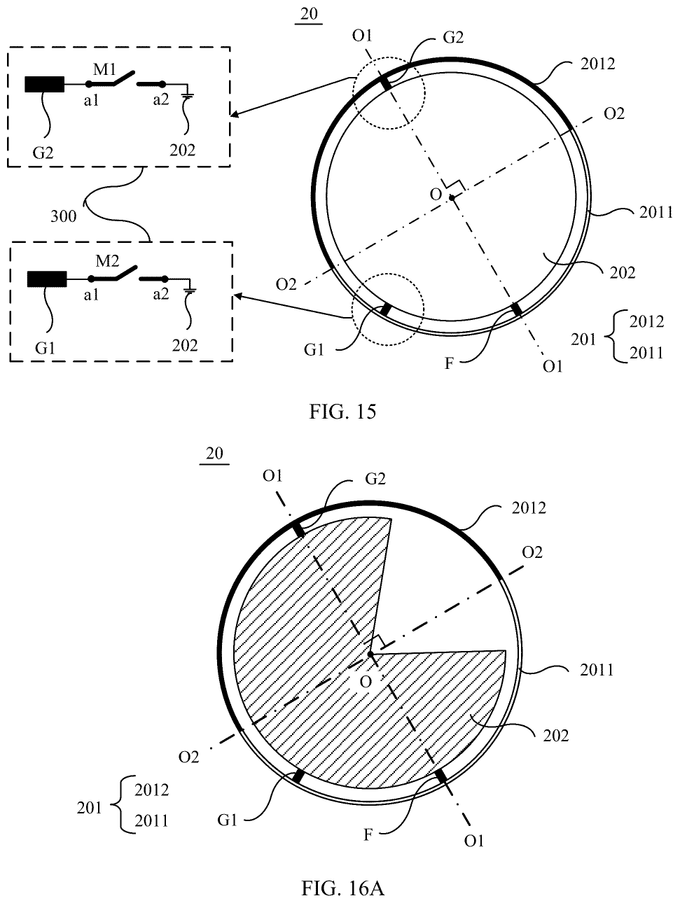

In a simple model shown in FIG. 12, the ground plate 202 is simplified into a complete and uniform circular solid ground plate. The ground plate 202 and the ring-shaped radiator 201 are disposed concentrically, and the ground plate 202 and the ring-shaped radiator 201 are disposed on a same plane. However, when a position of another mechanical part and/or a component inside the electronic device 01 is considered, there is a specific difference between a structure of the ground plate 202 of the simple model and a structure of the ground plate 202 of an entire device. For example, as shown in FIG. 16A, the ground plate 202 (for example, including the circuit board 14 shown in FIG. 1) has a specific notch, so that a structure that is substantially I-shaped, L-shaped, or U-shaped may be formed. In this way, specific space may be spared by using the notch to place another mechanical part and/or component inside the electronic device 01.

Based on this, still as shown in FIG. 16A, when a position of the notch is close to a position of the second ground end G2, a current on the ground plate 202 near the second ground end G2 may decrease, thereby affecting the CM mode of the ring-shaped radiator 201. Therefore, to enable the ring-shaped radiator 201 to operate in the CM mode more easily, in some embodiments of this application, as shown in FIG. 16B, in addition to the feeding end F, the first ground end G1, and the second ground end G2, the antenna structure 20 may further include a third ground end G3. A manner of disposing the first ground end G1 and the second ground end G2 is the same as that described above, and details are not described herein again.

Based on this, still as shown in FIG. 16B, the third ground end G3 may be disposed on the ring-shaped radiator 201 (for example, the first semi-ring 2011 or the second semi-ring 2012), and the third ground end G3 may be coupled to the ground plate 202. In addition, the third ground end G3 and the first ground end G2 may be respectively located on two sides of the first center line O1-O1. There may be a fourth included angle γ4 between the second center line O1-O1 and a connection line between the third ground end G3 and the geometric center O, and γ4 ranges from 0° to 60°. Compared with the feeding end F, the third ground end G3 is disposed closer to the second ground end G2.

In this way, still as shown in FIG. 16B, it can be learned from the foregoing that there is a first included angle γ1 between the first center line O1-O1 and a connection line between the second ground end G2 and the geometric center O, and γ1 ranges from −60° to +60°. Based on this, there may be the fourth included angle γ4 between the second center line O1-O1 and the connection line between the third ground end G3 and the geometric center O, and γ4 ranges from 0° to 60°. In addition, relative to the feeding end F: The third ground end G3 is disposed closer to the second ground end G2, so that when the third ground end G3 is coupled to the ground plate 202, a ground plate current excited by the third ground end G3 on the ground plate 202 may be superimposed with a ground plate current excited by the second ground end G2 on the ground plate 202. Therefore, under joint action of the feeding end F, the second ground end G2, and the third ground end G3, the ring-shaped radiator 201 can more easily operate in the CM mode. In addition, in the CM mode, the electromagnetic wave radiated by the ring-shaped radiator 201 has better directivity in the 6 o'clock direction, and a signal is stronger.

In addition, in the simple model shown in FIG. 12, because the ground plate 202 is simplified to be disposed on a same plane as the ring-shaped radiator 201, radiation space of the ring-shaped radiator 201 is open, so that simulation data of the simple model is more easily obtained. When the ring-shaped radiator 201 operates in the CM mode, the main beam direction of the electromagnetic wave of the ring-shaped radiator 201 faces the 6 o'clock position shown in FIG. 9C. However, in the entire system, the frame 11 shown in FIG. 1 has a specific height or thickness, and the ground plate 202 is not disposed in a same plane as the ring-shaped radiator 201, so that radiation space of the ring-shaped radiator 201 is not open. In this way, due to impact of the height of the frame 11, when the ring-shaped radiator 201 operates in the CM mode, a directivity pattern of the ring-shaped radiator 201 tilts at a position of 90° shown in FIG. 10C, thereby reducing a degree of coincidence with the position of 90°. In this way, the main beam direction of the electromagnetic wave of the ring-shaped radiator 201 deviates from the 6 o'clock position shown in FIG. 9C.

Based on this, the third ground end G3 shown in FIG. 16B is disposed. Because the ground plate current excited by the third ground end G3 on the ground plate 202 may be superimposed with the ground plate current excited by the second ground end G2 on the ground plate 202, impact of the height of the frame 11 in FIG. 1 on the directivity pattern of the ring-shaped radiator 201 at the position of 90° can be reduced, and a probability that the directivity pattern of the ring-shaped radiator 201 overlaps the position of 90° shown in FIG. 10C can be increased. In this way, the main beam direction of the electromagnetic wave of the ring-shaped radiator 201 faces the 6 o'clock position shown in FIG. 9C.

Alternatively, in some other embodiments of this application, to enable the ring-shaped radiator 201 to operate in the CM mode more easily under joint action of the feeding end F, the second ground end G2, and the third ground end G3, as shown in FIG. 16B, on the ring-shaped radiator 201, a minimum physical length from the third ground end G3 to the second center line O2-O2 is L3, and L3 ranges from 0 to 8.5π millimeters.

In addition, the third ground end G3 is disposed, so that when the ring-shaped radiator 201 operates in the CM mode, a frequency of a signal radiated by the ring-shaped radiator 201 may be adjusted, so that the frequency of the signal radiated by the ring-shaped radiator 201 is the L1 frequency band of the GPS. Alternatively, compared with a solution in which the third ground end G3 is not disposed, the frequency of the signal radiated by the ring-shaped radiator 201 is closer to the L1 frequency band of the GPS. In addition, the third ground end G3 is disposed, so that when the ring-shaped radiator 201 operates in the CM mode, impact on the frequency and performance of the radiation signal of the ring-shaped radiator 201 in the DM mode can be further avoided.

FIG. 16B is described by using an example in which the third ground end G3 is physically grounded to the ground plate 202. In some other embodiments of this application, as shown in FIG. 17, the antenna structure 20 further includes a switch assembly 300. The switch assembly 300 may be coupled between the ring-shaped radiator 201 and the ground plate 202, and one end of the switch assembly 300 may be coupled to the ring-shaped radiator 201 through the second ground end G2 or the third ground end G3.

For example, as shown in FIG. 17, the switch assembly 300 may include a third switch M3, the third switch M3 may be disposed between the third ground end G3 and the ground plate 202, a first end a1 of the third switch M3 is coupled to the third ground end G3, and a second end a2 of the third switch M3 may be coupled to the ground plate 202.

Based on this, when the third switch M3 is in a second state, at the target frequency, for example, the L1 frequency band of the GPS, the third ground end G3 is electrically isolated from the ground plate 202, and the first ground end G1 and the second ground end G2 of the antenna structure 20 are electrically connected to the ground plate 202. When the first switch M1 is in the first state, the first ground end G1, the second ground end G2, and the third ground end G3 of the antenna structure 20 are electrically connected to the ground plate 202.

Similarly, when the third switch M3 is disposed between the third feeding end G3 and the ground plate 202, a manner of disposing the impedance network shown in FIG. 13A and FIG. 13B may also be used between the third feeding end G3 and the ground plate 202. Details are not described again.

Alternatively, for another example, the switch assembly 300 may include at least one of the first switch M1 and the second switch M2 shown in FIG. 15. A manner of disposing the first switch M1 and the second switch M2 is the same as that described above, and details are not described herein again. Alternatively, for another example, the switch assembly 300 may include at least one of the third switch M3 in FIG. 17 and the first switch M1 and the second switch M2 shown in FIG. 15. Based on this, when the first switch M1 is in the second state, the second ground end G2 may be electrically isolated from the ground plate 202 at the target frequency. When the first ground end G1 and the third ground end G3 are coupled to the ground plate 202, the third ground end G3 may further adjust impedance, tuning, and performance of the DM mode of the ring-shaped radiator 201.

When the electronic device 01 is the smartwatch, the following describes, by using an example, disposing positions of the feeding end F, the first ground end G1, the second ground end G2, and the third ground end G3 in the antenna structure 20.

In addition, it can be learned from FIG. 10A, FIG. 10B, and FIG. 10C that, when the operating mode of the ring-shaped radiator 201 is switched from the DM mode to the CM mode, at a 6 o'clock position and the position near the 6 o'clock position, for example, a position that deviates from 6 o'clock about 60°, for example, an 8 o'clock position or a 4 o'clock position, a directivity coefficient of the ring-shaped radiator 201 increases obviously. For example, the directivity coefficient may increase by about 4 dB. Therefore, in this embodiment of this application, a position that is on the ring-shaped radiator 201 and that corresponds to the 6 o'clock position or the position near the 6 o'clock position in the electronic device 01, for example, the position that deviates from 6 o'clock about 60°, may be referred to as a “preset position.”

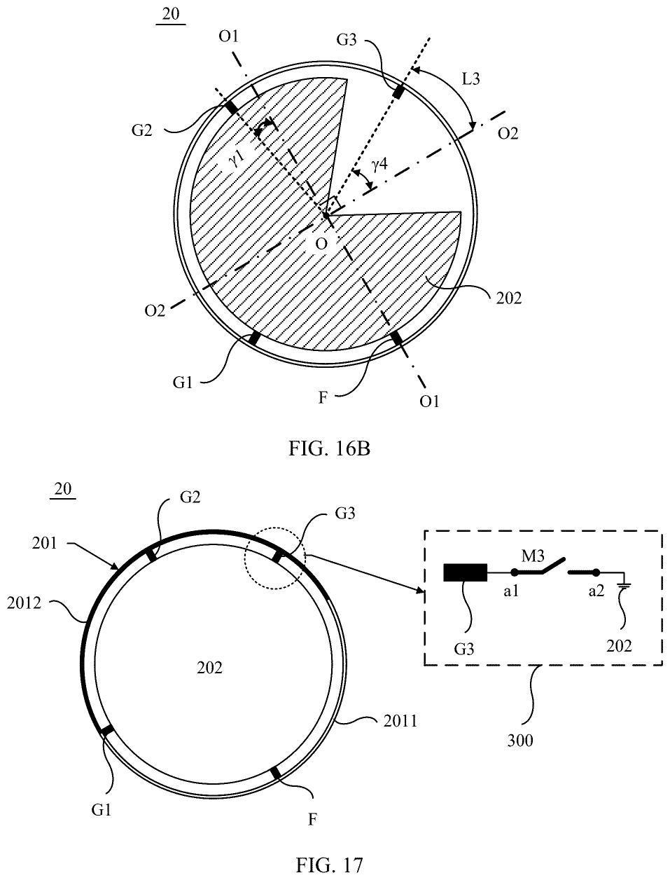

That a preset position P shown in FIG. 18 corresponds to the 6 o'clock position or the position near the 6 o'clock position (for example, a 4 o'clock position, a 5 o'clock position, a 7 o'clock position, or an 8 o'clock position) in the electronic device 01 means that a vertical projection of the preset position P on the ring-shaped radiator 201 on the rear cover 12 (as shown in FIG. 1), a vertical projection of the 6 o'clock position or the position near the 6 o'clock position of the watch face pattern 200 on the rear cover 12 (as shown in FIG. 1) and a geometric center of the watch face pattern 200 (or the geometric center O of the ring-shaped radiator 201) are collinear.

Based on this, as shown in FIG. 18, the ring-shaped radiator 201 may further have a third center line O3-O3, the geometric center O and the preset position P of the ring-shaped radiator 201 are located on the third center line O3-O3, and the third center line O3-O3 may be related to a radiation direction. In some embodiments of this application, there is a second included angle γ2 between the first center line O1-O1 and the third center line O3-O3. γ2 ranges from −60° to 60°. It can be learned from the foregoing that the feeding end F is located on the first center line O1-O1, and the feeding end F of the antenna structure 20 may be disposed at the 4 o'clock position, the 5 o'clock position, the 6 o'clock position, the 7 o'clock position, or the 8 o'clock position.

In this way, when the electronic device 01 is the smartwatch shown in FIG. 19, the display 10 (as shown in FIG. 1) of the electronic device 01 may display the watch face pattern 200 shown in FIG. 19. When the user wears the smartwatch, the arm 100 of the user overlaps a part of an area of the watch face pattern 200, for example, an area from 2 o'clock to 4 o'clock and an area from 8 o'clock to 9 o'clock. Therefore, when the feeding end F of the antenna structure 20 may be disposed at the 4 o'clock position, the 5 o'clock position, the 6 o'clock position, the 7 o'clock position, or the 8 o'clock position, impact of the arm 100 of the user on radiation signal performance of the ring-shaped radiator 201 can be reduced. In addition, due to a limitation of layout space of a component in the smartwatch, the feeding end F of the antenna structure 20 may be disposed at the 5 o'clock position or the 7 o'clock position.

It should be understood that, in this embodiment of this application, that the feeding end or the ground end is disposed at a time point of the watch face pattern 200 means a vertical projection of the feeding end or the ground end on the rear cover 12 (as shown in FIG. 1), a vertical projection of a position of the watch face pattern 200 at a time point on the rear cover 12 (as shown in FIG. 1), and a geometric center of the watch face pattern 200 are collinear. In this case, when a position of the feeding end or the ground end is located on a connection line between the time point of the watch face pattern 200 and the geometric center of the watch face pattern 200, it indicates that the feeding end or the ground end is disposed at a position of the time point of the watch face pattern 200. The geometric center of the watch face pattern 200 in this application may overlap the geometric center O of the ring-shaped radiator 201.

For example, that the feeding end F of the antenna structure 20 may be disposed at a 5 o'clock position or a 7 o'clock position means a vertical projection of the feeding end F on the rear cover 12 (as shown in FIG. 1), a vertical projection of the watch face pattern 200 at the 5 o'clock position or the 7 o'clock position on the rear cover 12 (as shown in FIG. 1), and the geometric center of the watch face pattern 200 are collinear. It can be learned from the foregoing that collinearity of the three elements may be understood as that a connection line or an extension line of two elements has an intersection point with the other element, or a shortest distance between the connection line or the extension line and the other element is within a range of 2 mm. For example, that the vertical projection of the feeding end F on the rear cover 12 (as shown in FIG. 1), the vertical projection of the 5 o'clock position or the 7 o'clock position of the watch face pattern 200 on the rear cover 12 (as shown in FIG. 1), and the geometric center of the watch face pattern 200 are collinear means that a shortest distance between the vertical projection of the feeding end F on the rear cover 12, the vertical projection of the 5 o'clock position of the watch face pattern 200 on the rear cover 12, and the vertical projection of the 7 o'clock position of the watch face pattern 200 on the rear cover 12 is within the range of 2 mm.

Still as shown in FIG. 18, when the feeding end F of the antenna structure 20 is disposed at the 5 o'clock position, it can be learned from the foregoing that there is a first included angle γ1 between the first center line O1-O1 and a connection line between the second ground end G2 and the geometric center O, and γ1 ranges from −60° to +60°. Therefore, the second ground end G2 may be disposed at a 9 o'clock position, a 10 o'clock position, an 11 o'clock position, a 12 o'clock position, or a 1 o'clock position.

For example, due to a limitation of layout space of a component in the smartwatch, when the feeding end F of the antenna structure 20 is disposed at the 5 o'clock position, the second ground end G2 may be disposed at the 11 o'clock position (or the 1 o'clock position). In this case, a vertical projection of the 11 o'clock position (or the 1 o'clock position) in the watch face pattern on the rear cover 12 (as shown in FIG. 1), a vertical projection of the second ground end G2 of the antenna structure 20 on the rear cover 12 (as shown in FIG. 1), and the geometric center of the watch face pattern 200 are collinear.

Based on this, when the second ground end G2 is disposed on the first center line O1-O1, the second ground end G2 may be disposed at the 11 o'clock position. In this case, the vertical projection of the 11 o'clock position in the watch face pattern on the rear cover 12 (as shown in FIG. 1), the vertical projection of the second ground end G2 of the antenna structure 20 on the rear cover 12 (as shown in FIG. 1), and the geometric center of the watch face pattern are collinear. In this way, when the second ground end G2 is physically grounded or grounded through a component, the ring-shaped radiator 201 is excited by the feeding end F and the second ground end G2, and the ring-shaped radiator 201 operates mainly in the CM mode, the frequency of the ring-shaped radiator 201 may be or close to the L1 frequency band of the GPS.

In addition, it can be learned from the foregoing that, as shown in FIG. 18, there is a third included angle γ3 between the first center line O1-O1 and a connection line between the first ground end G1 and the geometric center O, and γ3 ranges from −90° to +90°. Based on this, in some embodiments of this application, due to a limitation of layout space of a component in the smartwatch, as shown in FIG. 18, when the feeding end F of the antenna structure 20 is disposed at the 5 o'clock position, the first ground end G1 may be disposed at the 7 o'clock position. In this case, a vertical projection of the 7 o'clock position in the watch face pattern on the rear cover 12 (as shown in FIG. 1), a vertical projection of the first ground end G1 of the antenna structure 20 on the rear cover 12 (as shown in FIG. 1), and the geometric center of the watch face pattern 200 are collinear.

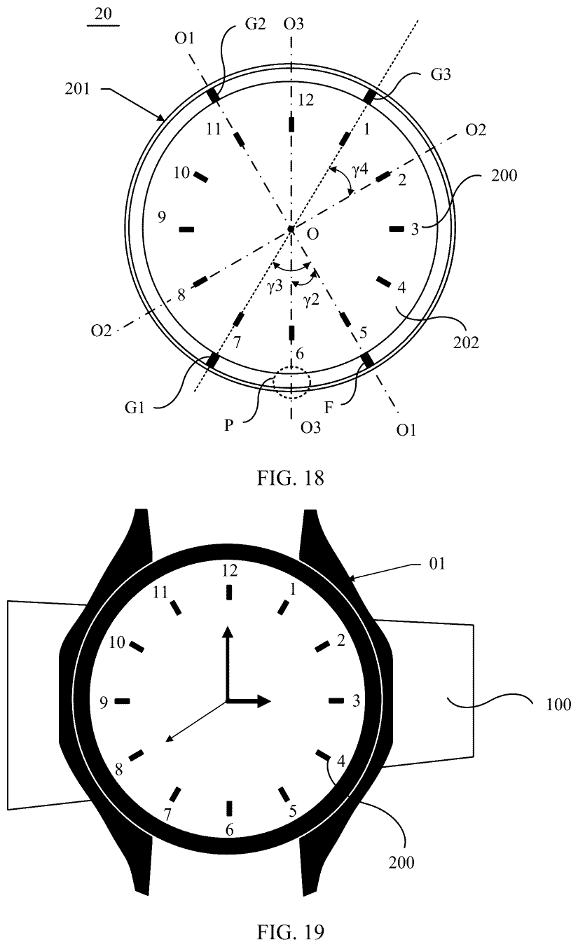

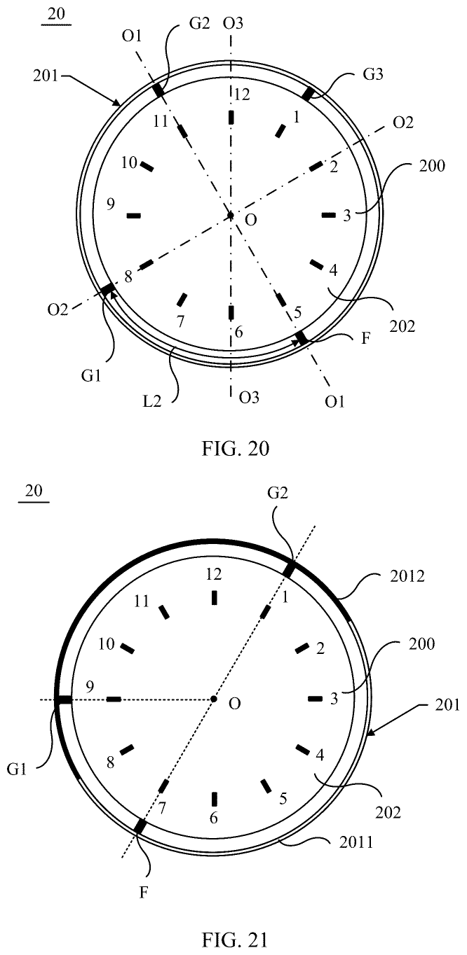

Alternatively, as shown in FIG. 20, when the feeding end F of the antenna structure 20 is disposed at the 5 o'clock position, the first ground end G1 may be disposed at the 8 o'clock position. In this case, a vertical projection of the 8 o'clock position in the watch face pattern on the rear cover 12 (as shown in FIG. 1), a vertical projection of the first ground end G1 of the antenna structure 20 on the rear cover 12 (as shown in FIG. 1), and the geometric center of the watch face pattern 200 are collinear. Alternatively, when the feeding end F is disposed at the 7 o'clock position, the first ground end G1 may be disposed at the 5 o'clock position.

In addition, it can be learned from the foregoing that, as shown in FIG. 18, there may be a fourth included angle γ4 between the second center line O1-O1 and a connection line between the third ground end G3 and the geometric center O, and γ4 ranges from 0° to 60°. Based on this, in some embodiments of this application, when the feeding end F of the antenna structure 20 is disposed at the 5 o'clock position, the first ground end G1 is disposed at the 7 o'clock position (or the 8 o'clock position), and the second ground end G2 is disposed at the 11 o'clock position, due to a limitation of layout space of a component in the smartwatch, the third ground end G3 may be disposed at the 1 o'clock position, so that a vertical projection of the 1 o'clock position in the watch face pattern 200 on the rear cover 12 (as shown in FIG. 1), a vertical projection of the third ground end G3 on the rear cover 12 (as shown in FIG. 1), and the geometric center of the watch face pattern 200 are collinear.

FIG. 18 is an example of disposing positions of the feeding end F, the first ground end G1, and the second ground end G2 on the ring-shaped radiator 201 by using the second included angle γ2, the first included angle γ1, and the third included angle γ3. In some other embodiments of this application, the disposing positions of the feeding end F, the first ground end G1, and the second ground end G2 may alternatively not be limited by the second included angle γ2, the first included angle γ1, and the third included angle γ3.

For example, as shown in FIG. 21, when the feeding end F of the antenna structure 20 is disposed at the 7 o'clock position, a vertical projection of the 7 o'clock position in the watch face pattern 200 on the rear cover 12 (as shown in FIG. 1), a vertical projection of the feeding end F of the antenna structure 20 on the rear cover 12 (as shown in FIG. 1), and the geometric center of the watch face pattern 200 are collinear. In this case, the second ground end G2 may be disposed at the 1 o'clock position, so that a vertical projection of the 1 o'clock position in the watch face pattern on the rear cover 12 (as shown in FIG. 1), the second ground end G2 of the antenna structure 20 on the rear cover 12 (as shown in FIG. 1), and the geometric center of the watch face pattern 200 are collinear. On this basis, the first ground end G1 may be disposed at the 9 o'clock (or the 11 o'clock position) position, so that a vertical projection of the 9 o'clock (or the 11 o'clock position) position in the watch face pattern 200 on the rear cover 12 (as shown in FIG. 1), a vertical projection of the first ground end G1 of the antenna structure 20 on the rear cover 12 (as shown in FIG. 1), and the geometric center of the watch face pattern 200 are collinear.

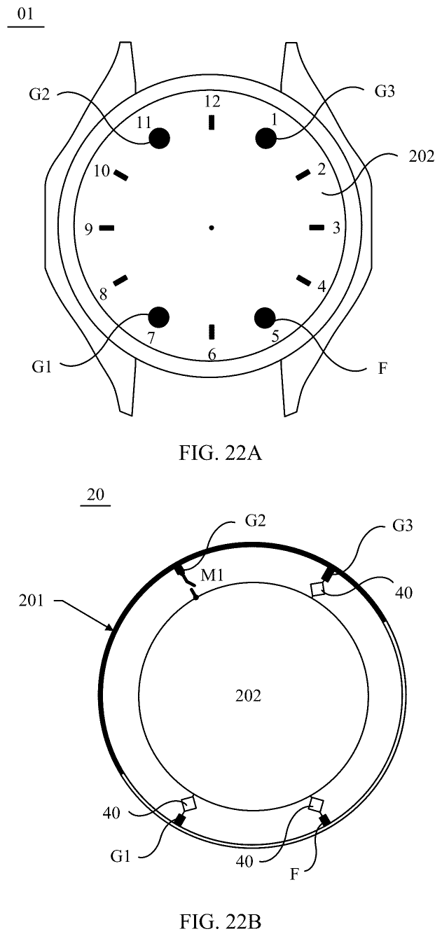

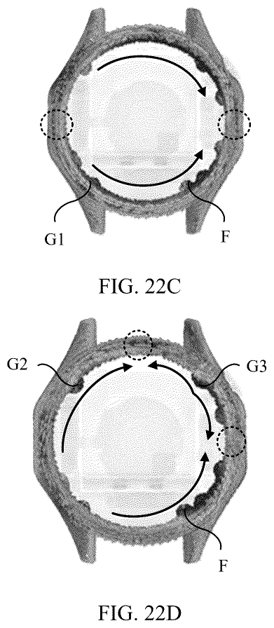

The foregoing is an example of disposing the positions of the feeding end F, the first ground end G1, and the second ground end G2 in the antenna structure 20. Other disposing manners are not described one by one. For ease of description, the following uses an example that the feeding end F is disposed at the 5 o'clock position, the first feeding end G1 is disposed at the 7 o'clock position, the second ground end G2 is disposed at the 11 o'clock position, and the third ground end is disposed at the 1 o'clock position shown in FIG. 22A for description.

For example, the first switch M1 shown in FIG. 22B may be disposed between the second ground end G2 and the ground plate 202, and the first ground end G1 and the third ground end G3 may be physically grounded or may be grounded through a component by disposing an impedance network 40 An impedance network (not shown in the figure) used for impedance matching may be disposed between the feeding end F and a feed (not shown in the figure). The impedance network 40 may implement 0 ohm grounding of the ground end. Alternatively, for another example, the impedance network 40 may have an impedance matching function, so that an S parameter in the target frequency state can be tuned based on simulation and actual debugging.

Based on this, for example, the first switch M1 may be controlled to be in the second state, so that the second ground end G2 is electrically isolated from the ground plate 202 at the target frequency, for example, in the L1 frequency band of the GPS. The first ground end G1 and the third ground end G3 may be electrically connected to the ground plate 202. In this case, a current distribution diagram of the electronic device 01 may be shown in FIG. 22C. It can be learned that a feature of the diagram includes: A current distributed on the ring-shaped radiator has two current zero points (a light-colored part circled by dashed lines in the figure). Current flow directions between the two adjacent current zero points are the same. This belongs to the “DM mode” in this embodiment of this application.

Alternatively, for another example, the first switch M1 may be controlled to be in the first state. In this case, both the second ground end G2 and the third ground end G3 may be electrically connected to the ground plate 202. In this case, a current distribution diagram of the electronic device 01 may be shown in FIG. 22D. It can be learned that a feature of the diagram includes: Current flow directions of are opposite between two adjacent current zero points (a light-colored part circled by dashed lines in the figure) at which a current is distributed on the ring-shaped radiator. For example, current flow directions on two sides of the third ground end G3 are opposite. This belongs to the “CM mode” in this embodiment of this application.

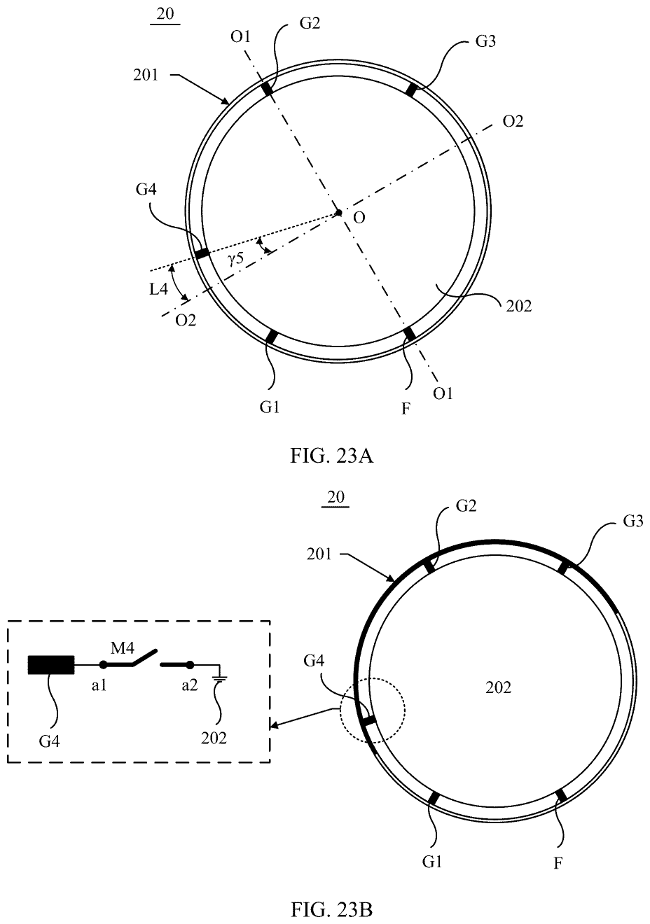

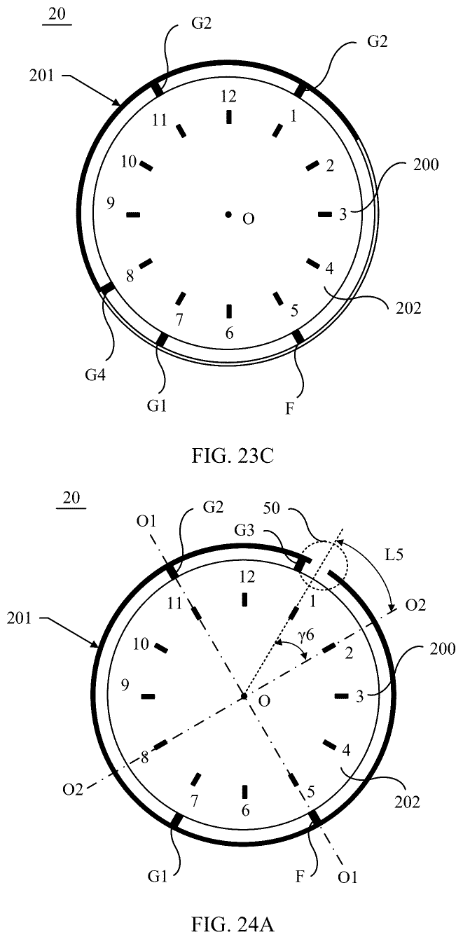

The foregoing is described by using an example in which the antenna structure 20 has three ground ends, for example, the first ground end G1, the second ground end G2, and the third ground end G3. In some other embodiments of this application, as shown in FIG. 23A, the antenna structure 20 may further include a fourth ground end G4. The fourth ground end G4 may be disposed on the ring-shaped radiator 201. The fourth ground end G4 is coupled to the ground plate 202. The fourth ground end G4 and the third ground end G3 are respectively located on two sides of the first center line O1-O1. In this way, the fourth ground end G4 is disposed, so that when the first ground end G1 is electrically connected to the ground plate 202, and the ring-shaped radiator 201 operates in the DM mode, the frequency of the signal radiated by the ring-shaped radiator 201 can be adjusted, so that the frequency of the signal radiated by the ring-shaped radiator 201 is the target frequency, for example, the L1 frequency band of the GPS. Alternatively, in comparison with a solution in which the fourth ground end G4 is not disposed, the frequency of the signal radiated by the ring-shaped radiator 201 is closer to the target frequency.

On this basis, the antenna structure 20 may further include a fourth switch M4 shown in FIG. 23B. The fourth switch M4 may be disposed between the fourth ground end G4 and the ground plate 202. A first end a1 of the fourth switch M4 is coupled to the fourth ground end G4. A second end a2 of the fourth switch M4 may be coupled to the ground plate 202. Based on this, when the fourth switch M4 is in a second state, at the target frequency, for example, the L1 frequency band of the GPS, the fourth switch M4 is electrically isolated from the ground plate 202, and the first ground end G1, the second ground end G2, and the third ground end G3 of the antenna structure 20 are electrically connected to the ground plate 202. When the fourth switch M4 is in a first state, the first ground end G1, the second ground end G2, the third ground end G3, and the fourth ground end G4 of the antenna structure 20 are electrically connected to the ground plate 202. Similarly, when the fourth switch M4 is disposed between the fourth ground end G4 and the ground plate 202, a manner of disposing the impedance network shown in FIG. 13A and FIG. 13B may also be used between the fourth ground end G4 and the ground plate 202. Details are not described herein again.

In some embodiments of this application, still as shown in FIG. 23A, there is a fifth included angle γ5 between the second center line O2-O2 and a connection line between the fourth ground end G4 and the geometric center O, and γ5 ranges from −60° to +60°. In this way, when the fourth ground end G4 is disposed at any point on the ring-shaped radiator 201 within a range of the fifth included angle γ5, and the fourth ground end G4 is physically grounded or grounded through a component to the ground plate 202, the frequency of the signal radiated by the ring-shaped radiator 201 is more likely to reach the target frequency.

Alternatively, in some other embodiments of this application, as shown in FIG. 23A, on the ring-shaped radiator 201, a minimum physical length from the fourth ground end G4 to the second center line O2-O2 is L4, and L4 ranges from 0 to 8.5π millimeters. Technical effect of a size range of L4 is the same as technical effect of a setting range of the fourth included angle γ4. Details are not described herein again.

In addition, as shown in FIG. 23C, due to a limitation of layout space of a component in the smartwatch, the first ground end G1 is disposed at a 7 o'clock position, so that a vertical projection of the 7 o'clock position in the watch face pattern on the rear cover 12 (as shown in FIG. 1), a vertical projection of the first ground end G1 of the antenna structure 20 on the rear cover 12, and the geometric center of the watch face pattern 200 are collinear. In addition, the fourth ground end G4 may be disposed at an 8 o'clock position, so that a vertical projection of the 8 o'clock position in the watch face pattern on the rear cover 12, a vertical projection of the fourth ground end G4 on the rear cover 12, and the geometric center of the watch face pattern 200 are collinear.

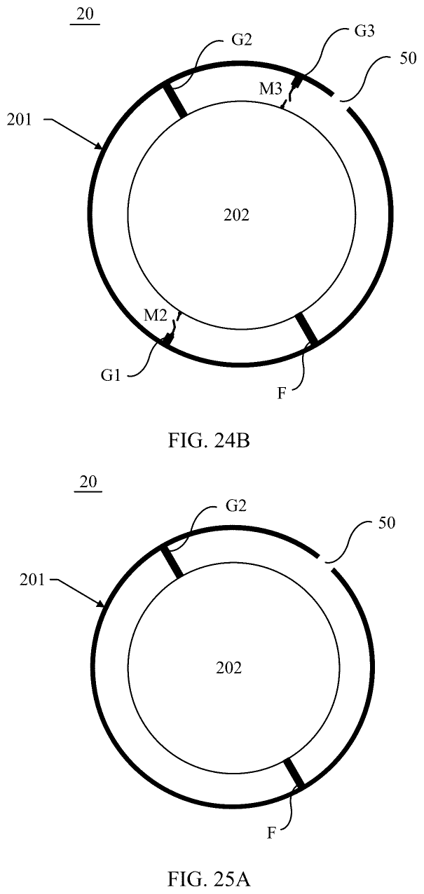

The foregoing embodiment is described by using an example in which the ring-shaped radiator 201 is not slit, and the ring-shaped radiator 201 may be a complete ring-shaped conductor. For example, the ring-shaped radiator 201 may be a ring-shaped conductive structure with a closed head and tail. In some other embodiments of this application, as shown in FIG. 24A, a slot 50 is disposed on the ring-shaped radiator 201, and the slot 50 and the first ground end G1 may be respectively located on two sides of the first center line O1-O1. In this way, the slot 50 is disposed, so that the ring-shaped radiator 201 can more easily excite the CM mode when the second ground end G2 is coupled to the ground plate 202.

Based on this, for example, still as shown in FIG. 24A, there is a sixth included angle γ6 between the second center line O2-O2 and a connection line between the geometric center and the geometric center of the slot 50, and γ6 ranges from −30° to +30°. In this way, when the slot 50 is disposed in the sixth included angle γ6, the slot 50 may be disposed in a large current area (a part with a dark color) in an upper right corner in FIG. 22D. This is more conducive to excitation of the CM mode of the ring-shaped radiator 201.

In addition, still as shown in FIG. 24A, the second ground end G2 is disposed at the 11 o'clock position, so that when a vertical projection of the 11 o'clock position in the watch face pattern 200 on the rear cover 12 (as shown in FIG. 1), a vertical projection of the second ground end G2 of the antenna structure 20 on the rear cover 12, and the geometric center of the watch face pattern 200 are collinear, the slot 50 may be disposed at the 1 o'clock position. In this way, a vertical projection of the 1 o'clock position in the watch face pattern 200 on the rear cover 12, a vertical projection of the slot 50 of the antenna structure 20 on the rear cover 12, and the geometric center of the watch face pattern 200 are collinear.

Alternatively, in some other embodiments of this application, as shown in FIG. 24A, on the ring-shaped radiator 201, a minimum physical length from the slot 50 to the second center line O2-O2 is L5, and L5 ranges from 3π to 4.5π millimeters. Technical effect of a size range of L5 is the same as technical effect of a setting range of the fifth included angle γ5. Details are not described herein again.

Based on this, in some embodiments of this application, as shown in FIG. 24B, the second ground end G2 may be physically grounded or may be grounded through a component to the ground plate 202. The first ground end G1 may be electrically connected to the ground plate 202 through the second switch M2, and the third ground end G3 may be electrically connected to the ground plate 202 through the third switch M3. In this case, when both the second switch M2 and the third switch M3 in FIG. 24B are in the second state, the first ground end G1 and the third ground end G3 are electrically isolated from the ground plate 202 at the target frequency.

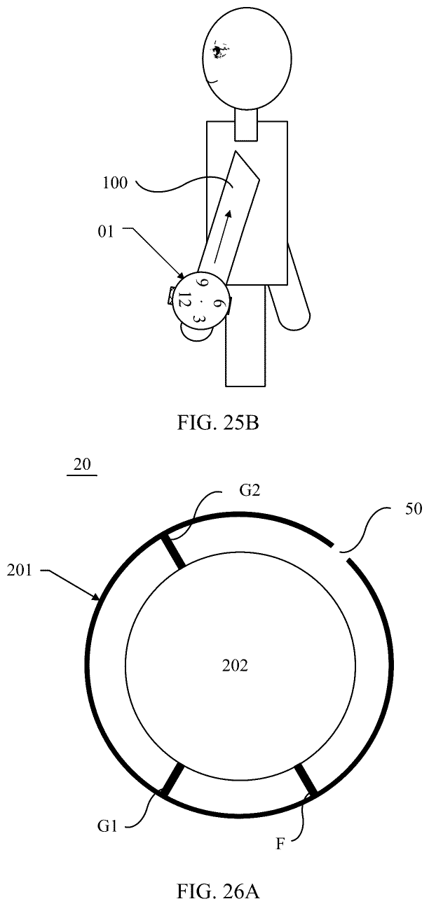

In this case, as shown in FIG. 25A, the second ground end G2 is electrically connected to the ground plate 202. Therefore, under excitation of the feeding end F, the second ground end G2, and the slot 50, the ring-shaped radiator 201 is excited to operate mainly in the CM mode. In this case, a beam direction of an electromagnetic wave radiated by the ring-shaped radiator 201 is parallel to a surface of a watch face of the electronic device 01, for example, a smartwatch. In this case, when the user wears the electronic device 01, for example, the smartwatch, as shown in FIG. 25B, the arm 100 of the user is vertically placed in the figure, so that the watch face of the watch is vertically placed, and the arm of the user naturally drops (for example, the user is in a walking state, and the electronic device 01 is worn on the left hand). Because the beam direction (the direction shown by an arrow in the figure) of the electromagnetic wave radiated by the ring-shaped radiator 201 is parallel to the surface of the watch face, the main beam direction of the electromagnetic wave of the ring-shaped radiator 201 may face the 9 o'clock position and the position near the 9 o'clock position (for example, the 8 o'clock position or the 10 o'clock position), and may still face the sky.

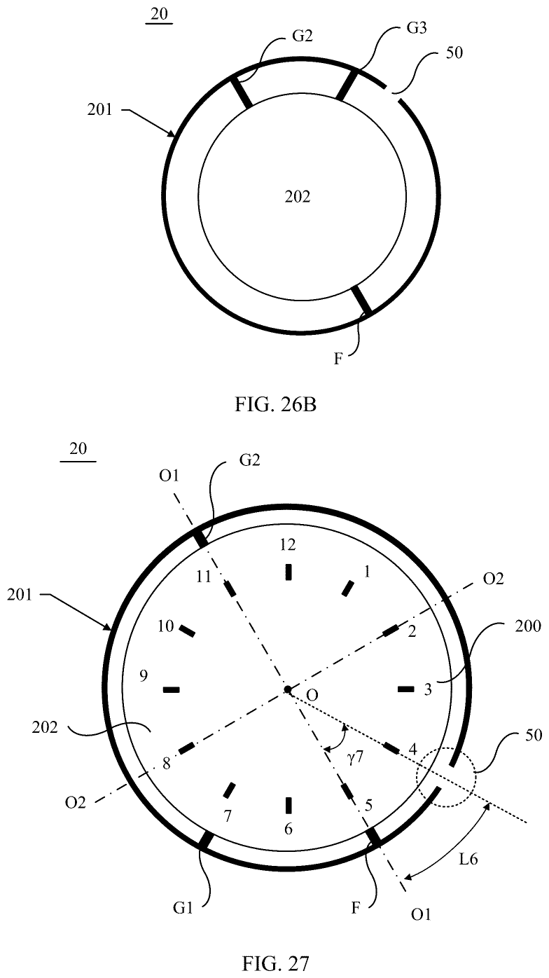

Alternatively, for another example, when the second switch M2 in FIG. 24B is in the first state, and the third switch M3 is in the second state, the third ground end G3 is electrically isolated from the ground plate 202 at the target frequency. In this case, as shown in FIG. 26A, both the second ground end G2 and the first ground end G1 may be electrically connected to the ground plate 202. Therefore, under excitation of the feeding end F, the first ground end G1, the second ground end G2, and the slot 50, the ring-shaped radiator 201 operates mainly in the DM mode. The beam direction of the electromagnetic wave radiated by the ring-shaped radiator 201 is perpendicular to the surface of the watch face of the electronic device 01, for example, the smartwatch. In this case, when the user wears the electronic device 01, for example, the smartwatch, as shown in FIG. 6A, the arm 100 of the user is horizontally placed in the figure, so that the watch face of the watch is horizontal and faces the sky. In this case, the beam direction of the electromagnetic wave radiated by the ring-shaped radiator 201 is perpendicular to the surface of the watch face, and the beam direction (indicated by an arrow in the figure) of the electromagnetic wave faces the direction of the sky (upward).

Alternatively, for another example, when the second switch M2 in FIG. 24B is in the second state, and the third switch M3 is in the first state, the first ground end G1 is electrically isolated from the ground plate 202 at the target frequency. In this case, as shown in FIG. 26B, both the third ground end G3 and the second ground end G2 may be electrically connected to the ground plate 202. Therefore, under excitation of the feeding end F, the third ground end G3, the second ground end G2, and the slot 50, the ring-shaped radiator 201 is excited to operate mainly in the CM mode. In this case, when the user wears the electronic device 01, for example, the smartwatch, as shown in FIG. 9A, the arm 100 of the user is vertically placed in the figure, so that the watch face of the watch is vertically placed. The beam direction of the electromagnetic wave radiated by the ring-shaped radiator 201 is parallel to the surface of the watch face. Therefore, the main beam direction of the electromagnetic wave of the ring-shaped radiator 201 may face the 6 o'clock position and the position near the 6 o'clock position (for example, the 8 o'clock position or the 4 o'clock position), and may still face the sky.

In this way, when the user wears the electronic device 01, regardless of how the arm 100 of the user swings, that is, when the user lifts the arm 100 to make the arm 100 horizontally placed, when the user walks, the arm 100 naturally drops and is placed laterally, or when the arm 100 is lifted and placed laterally during running, the beam direction of the electromagnetic wave radiated by the ring-shaped radiator 201 in the electronic device 01 can point to the sky, so that satellite communication and positioning accuracy can be improved.

In some other embodiments of this application, when the slot 50 is disposed on the

ring-shaped radiator 201, as shown in FIG. 27, there is a seventh included angle γ7 between the first center line O1-O1 and a connection line between the slot 50 and the geometric center O, and γ7 ranges from −30° to +30°. In this way, when the slot 50 is disposed in the seventh included angle γ7, the slot 50 may be disposed in a large current area (a part with a dark color) in a lower right corner in FIG. 22D. This is more conducive to excitation of the CM mode of the ring-shaped radiator 201.

In addition, still as shown in FIG. 27, when the second ground end G2 is disposed at the 11 o'clock position, the slot 50 may be disposed at the 4 o'clock position. In this way, a vertical projection of the four o'clock position in the watch face pattern 200 on the rear cover 12, a vertical projection of the slot 50 of the antenna structure 20 on the rear cover 12, and the geometric center of the watch face pattern 200 are collinear.

In addition, in some other embodiments of this application, as shown in FIG. 27, on the ring-shaped radiator 201, a minimum physical length from the slot 50 to the first center line O1-O1 is L6, and L6 ranges from 3π to 4.5π millimeters. Technical effect of a size range of L6 is the same as technical effect of a setting range of the sixth included angle γ6. Details are not described herein again.

In some embodiments of this application, as shown in FIG. 28, the antenna structure 20 may include the ring-shaped radiator 201, the ground plate 202, the feeding end F, the second ground end G2, and the third ground end G3. A manner of disposing the ring-shaped radiator 201, the ground plate 202, the feeding end F, and the third ground end G3 is the same as that described above, and details are not described herein again. A difference from the foregoing embodiment lies in that, in this embodiment, the first ground end G1 may not be disposed in the antenna structure 20, there is a first included angle γ1 between the first center line O1-O1 and a connection line between the second ground end G2 and the geometric center O, and γ1 ranges from −15° to +15°.

In this way, when both the second ground end G2 and the third ground end G3 are coupled to the ground plate 202, the second ground end G2, the third ground end G3, and the feeding end F can more easily excite the ring-shaped radiator 201 to operate mainly in the CM mode. In addition, because γ1 ranges from −15° to +15°, the second ground end G2 and the feeding end F may be basically located at opposite positions on the ring-shaped radiator 201, so that a directivity coefficient of an electromagnetic wave radiated by the ring-shaped radiator 201 in a CM mode is larger, and signal strength is higher.

Alternatively, in some other embodiments of this application, to make it easier for the second ground end G2 and the feeding end F to excite the ring-shaped radiator 201 to operate mainly in the CM mode and radiate a stronger signal, as shown in FIG. 28, on the ring-shaped radiator 201, a minimum physical length from the second ground end G2 to the first center line O1-O1 is L1, and L1 ranges from 0 to 2π millimeters. For example, the second ground end G2 may be disposed on the first center line O1-O1. In this case, L1 may be 0. In this way, both the second ground end G2 and the feeding end F are disposed on the first center line O1-O1, so that the second ground end G2 and the feeding end F may be centrosymmetric with respect to the geometric center O.

Based on this, the antenna structure 20 further includes a switch assembly. For example, as shown in FIG. 15, the switch assembly 300 may include the first switch M1. Alternatively, as shown in FIG. 17, the switch assembly 300 may include the third switch M3. Disposal manners and technical effect of the switch assembly 300, the first switch M1, and the third switch M3 are the same as those described above, and details are not described herein again. In addition, when the first switch M1 is in the second state, the second ground end G2 is electrically isolated from the ground plate 202 at the target frequency, the third switch M3 is in the first state, and the third ground end G3 is electrically connected to the ground plate 202, the third ground end G3 and the feeding end F may excite the ring-shaped radiator 201 to operate mainly in the DM mode.

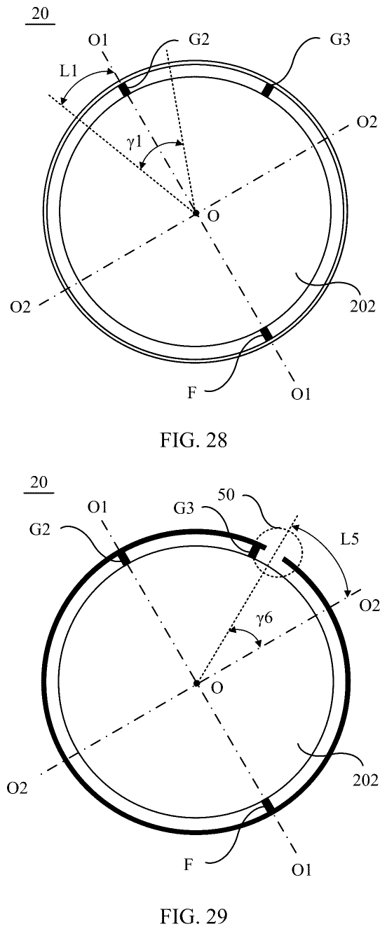

FIG. 28 is described by using an example in which no slot is disposed in the ring-shaped radiator 201. In some other embodiments of this application, as shown in FIG. 29, the slot 50 is disposed on the ring-shaped radiator 201, and the slot 50 and the first ground end G1 may be respectively located on two sides of the first center line O1-O1. Based on this, for example, still as shown in FIG. 29, there is a sixth included angle γ6 between the second center line O2-O2 and a connection line between the geometric center and the geometric center of the slot 50, and γ6 ranges from −30° to +30°. Alternatively, in some other embodiments of this application, as shown in FIG. 23B, on the ring-shaped radiator 201, a minimum physical length from the slot 50 to the second center line O2-O2 is L5, and L5 ranges from 3π to 4.5π millimeters. A disposing manner and technical effect of the slot 50 are the same as those described above, and details are not described herein again.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

What is claimed is:

1. An antenna structure, comprising:
a ring-shaped radiator, having a preset geometric center and a first center line and a second center line that are orthogonal to each other, wherein the geometric center is located at an intersection point of the first center line and the second center line, and the ring-shaped radiator is divided into a first semi-ring and a second semi-ring by the preset second center line;
a ground plate having a gap with at least a part of the ring-shaped radiator;
a feeding end, disposed on the first semi-ring and on the first center line;
a first ground end, disposed on the ring-shaped radiator, wherein the first ground end is coupled to the ground plate, there is a third included angle γ3 between the first center line and a connection line between the first ground end and the geometric center, γ3 ranges from −90° to +90°, and γ3 is not zero;
a second ground end, disposed on the second semi-ring, wherein the second ground end is coupled to the ground plate, there is a first included angle γ1 between the first center line and a connection line between the second ground end and the geometric center, and γ1 ranges from −60° to +60°;
a third ground end, disposed on the ring-shaped radiator, wherein the third ground end is coupled to the ground plate, the third ground end and the first ground end are respectively located on two sides of the first center line, there is a fourth included angle γ4 between the second center line and a connection line between the third ground end and the geometric center, γ4 ranges from 0° to 60°, and the third ground end is disposed close to the second ground end relative to the feeding end; and
a switch assembly, coupled between the ring-shaped radiator and the ground plate, wherein one end of the switch assembly is coupled to the ring-shaped radiator through at least one of the second ground end and the third ground end.

2. The antenna structure according to claim 1, wherein on the ring-shaped radiator, a minimum physical length from the second ground end to the first center line is L1, and L1 ranges from 0 to 8.5π millimeters.

3. The antenna structure according to claim 1, wherein the first included angle γ1 between the first center line and the connection line between the second ground end and the geometric center is −15° to +15°.

4. The antenna structure according to claim 1, wherein
on the ring-shaped radiator, a minimum physical length from the first ground end to the feeding end is L2, and L2 ranges from 6π millimeters to 12.5π millimeters.

5. The antenna structure according to claim 1, wherein
on the ring-shaped radiator, a minimum physical length from the third ground end to the second center line is L3, and L3 ranges from 0 to 8.5π millimeters.

6. The antenna structure according to claim 1, wherein
a preset position is disposed on the ring-shaped radiator, the ring-shaped radiator further has a preset third center line, the geometric center and the preset position are disposed on the third center line, and the third center line is related to a radiation direction; and
there is a second included angle γ2 between the first center line and the third center line, wherein γ2 ranges from −60° to +60°.

7. The antenna structure according to claim 1, wherein the switch assembly comprises:
a first switch, disposed between the second ground end and the ground plate, wherein a first end of the first switch is coupled to the second ground end, and a second end of the first switch is coupled to the ground plate.

8. The antenna structure according to claim 1, wherein the switch assembly comprises:
a third switch, disposed between the third ground end and the ground plate, wherein a first end of the third switch is coupled to the third ground end, and a second end of the third switch is coupled to the ground plate.

9. The antenna structure according to claim 1, wherein the antenna structure further comprises:
a second switch, disposed between the first ground end and the ground plate, wherein a first end of the second switch is coupled to the first ground end, and a second end of the second switch is coupled to the ground plate.

10. The antenna structure according to claim 1, wherein the antenna structure further comprises:
a fourth ground end, disposed on the ring-shaped radiator, wherein the fourth ground end is on the two sides of the first center line, there is a fifth included angle γ5 between the second center line and a connection line between the fourth ground end and the geometric center, and γ5 ranges from −60° to +60°.

11. The antenna structure according to claim 10, wherein
on the ring-shaped radiator, a minimum physical length from the fourth ground end to the second center line is L4, and L4 ranges from 0 to 8.5π millimeters.

12. The antenna structure according to claim 1, wherein no slot is disposed in the ring-shaped radiator.

13. The antenna structure according to claim 1, wherein
a slot is disposed in the ring-shaped radiator, the slot and the first ground end are respectively located on the two sides of the first center line, there is at least one of a sixth included angle γ6 and a seventh included angle γ7, wherein γ6 is an angle between the second center line and a connection line between the slot and the geometric center, and γ6 ranges from −30° to +30°; and wherein γ7 is an angle between the first center line and a connection line between the slot and the geometric center, and γ7 ranges from −30° to +30°.

14. The antenna structure according to claim 13, wherein at least one of the following is satisfied:
on the ring-shaped radiator, a minimum physical length from the slot to the second center line is L5, and L5 ranges from 3π to 4.5π millimeters; and
on the ring-shaped radiator, a minimum physical length from the slot to the first center line is L6, and L6 ranges from 3π to 4.5π millimeters.

15. An electronic device, comprising:
a cover plate;
a rear cover;
an antenna structure, comprising:
a ring-shaped radiator, having a preset geometric center and a first center line and a second center line that are orthogonal to each other, wherein the geometric center is located at an intersection point of the first center line and the second center line, and the ring-shaped radiator is divided into a first semi-ring and a second semi-ring by using the preset second center line;
a ground plate with a gap with at least a part of the ring-shaped radiator;
a feeding end, disposed on the first semi-ring and on the first center line;
a first ground end, disposed on the ring-shaped radiator, wherein the first ground end is coupled to the ground plate, there is a third included angle γ3 between the first center line and a connection line between the first ground end and the geometric center, γ3 ranges from −90° to +90°, and γ3 is not zero;
a second ground end, disposed on the second semi-ring, wherein the second ground end is coupled to the ground plate, there is a first included angle γ1 between the first center line and a connection line between the second ground end and the geometric center, and γ1 ranges from −60° to +60°;
a third ground end, disposed on the ring-shaped radiator, wherein the third ground end is coupled to the ground plate, the third ground end and the first ground end are respectively located on two sides of the first center line, there is a fourth included angle γ4 between the second center line and a connection line between the third ground end and the geometric center, γ4 ranges from 0° to 60°, and the third ground end is disposed close to the second ground end relative to the feeding end; and
a switch assembly, coupled between the ring-shaped radiator and the ground plate, wherein one end of the switch assembly is coupled to the ring-shaped radiator through the second ground end or the third ground end;
wherein the antenna structure is disposed between the cover plate and the rear cover, and the ring-shaped radiator of the antenna structure is used as at least a part of a frame of the electronic device.

16. The electronic device according to claim 15, wherein the electronic device further comprises:
a circuit board, wherein in a thickness direction of the electronic device, the circuit board and the frame are at least partially staggered, and the frame is disposed close to the cover plate relative to the circuit board; and
the thickness direction is a direction pointing from the rear cover to the cover plate.

17. The electronic device according to claim 15, wherein
the electronic device further comprises a display, the display is disposed between the rear cover and the cover plate, a display surface of the display faces the cover plate, and the display surface is configured to display a watch face pattern; and
a vertical projection of a 5 o'clock position in the watch face pattern on the rear cover, a vertical projection of a feeding end of the antenna structure on the rear cover, and a geometric center of the watch face pattern are collinear; and at least one of a vertical projection of an 11 o'clock position and a vertical projection of a 1 o'clock position, in the watch face pattern on the rear cover, a vertical projection of a second ground end of the antenna structure on the rear cover, and the geometric center of the watch face pattern are collinear.

18. The electronic device according to claim 17, wherein
the antenna structure comprises a first ground end and a third ground end, the first ground end is disposed on the ring-shaped radiator, the first ground end is coupled to a ground plate of the antenna structure, the third ground end is disposed on the ring-shaped radiator, the third ground end and the first ground end are respectively located on two sides of a first center line, and the third ground end is coupled to the ground plate of the antenna structure;
at least one of a vertical projection of a 7 o'clock position and a vertical projection of an 8 o'clock position, in the watch face pattern on the rear cover, a vertical projection of the first ground end of the antenna structure on the rear cover, and the geometric center of the watch face pattern are collinear; and
the vertical projection of the 11 o'clock position in the watch face pattern on the rear cover, the vertical projection of the second ground end of the antenna structure on the rear cover, and the geometric center of the watch face pattern are collinear; and the vertical projection of the 1 o'clock position in the watch face pattern on the rear cover, a vertical projection of the third ground end on the rear cover, and the geometric center of the watch face pattern are collinear.

19. The electronic device according to claim 18, wherein
the antenna structure further comprises a fourth ground end, the fourth ground end is disposed on the ring-shaped radiator, the fourth ground end is coupled to the ground plate, and the fourth ground end and the third ground end are respectively located on the two sides of the first center line; and
a vertical projection of a 7 o'clock position in the watch face pattern on the rear cover, the vertical projection of the first ground end of the antenna structure on the rear cover, and the geometric center of the watch face pattern are collinear; and the vertical projection of the 8 o'clock position in the watch face pattern on the rear cover, a vertical projection of the fourth ground end on the rear cover, and the geometric center of the watch face pattern are collinear.

20. The electronic device according to claim 15, wherein
the electronic device further comprises a display, the display is disposed between the rear cover and the cover plate, a display surface of the display faces the cover plate, and the display surface is configured to display a watch face pattern; and
a vertical projection of a 7 o'clock position in the watch face pattern on the rear cover, a vertical projection of a feeding end of the antenna structure on the rear cover, and a geometric center of the watch face pattern are collinear; and a vertical projection of a 1 o'clock position in the watch face pattern on the rear cover, a vertical projection of a second ground end of the antenna structure on the rear cover, and the geometric center of the watch face pattern are collinear.
